(19) United States
(12) Patent Application Publication
(10) Pub. No.: US 2025/0328065 A1
(43) Pub. Date: Oct. 23, 2025

(54) SCREEN FRAME AND PROJECTION SCREEN

(71) Applicant: HISENSE LASER DISPLAY CO., LTD., Qingdao (CN)

(72) Inventors: Qiang ZHONG, Qingdao (CN); Qi DAI, Qingdao (CN); Yungang YAO, Qingdao (CN); Jie DAI, Qingdao (CN); Xuexiang XIN, Qingdao (CN)

(21) Appl. No.: 19/258,223

(22) Filed: Jul. 2, 2025

Related U.S. Application Data
(63) Continuation of application No. PCT/CN2023/134968, filed on Nov. 29, 2023.

(30) Foreign Application Priority Data
Mar. 13, 2023 (CN) 202310238019.9
Jun. 12, 2023 (CN) 202321494511.4

(51) Int. Cl. G03B 21/58

(52) U.S. Cl. CPC G03B 21/58

(57) ABSTRACT

Disclosed is a screen frame, including two oppositely-arranged first foldable frame segments, two oppositely-arranged second foldable frame segments, and a third pivoting mechanism. Each of the first foldable frame segments comprises two first frame sub-segments and a first pivoting mechanism, the first pivoting mechanism is configured to drive the two first frame sub-segments to fold or unfold around a first axis parallel to the bearing surface; each of the second foldable frame segments comprises two second frame sub-segments, and at least one second foldable frame segment further comprises a second pivoting mechanism, the second pivoting mechanism is configured to drive two corresponding second frame sub-segments to fold or unfold around a second axis intersecting the bearing surface. The third pivoting mechanism is configured to drive the second frame sub-segment to rotate relative to the first frame sub-segment around a fourth axis perpendicular to the bearing surface.

This application continuation application of PCT application No. PCT/CN2023/134968 filed on Nov. 29, 2023, which claims priority to Chinese Patent Application No. 202310238019.9 filed on Mar. 13, 2023, and entitled “SCREEN FRAME AND PROJECTION SCREEN” and Chinese Patent Application No. 202321494511.4 filed on Jun. 12, 2023 and entitled “SCREEN FRAME AND PROJECTION SCREEN”, the contents of which are herein incorporated by reference in their entireties.

### TECHNICAL FIELD

The present disclosure relates to the field of projection displays, and in particular, relates to a screen frame and a projection screen.

### BACKGROUND

With the continuous development of technology, laser projection systems are increasingly applied to consumers' work and life. At present, a laser projection system mainly includes a laser projection device and a projection screen. The laser projection device emits a light beam to the projection screen, and the projection screen receives the light beam to achieve the display of an image.

In related art, the size of a projection screen is getting larger and larger, especially for a projection screen with a size of 100 inches and above. The projection screen occupies a relatively large space, which inevitably increases the difficulty of transporting the projection screen.

### SUMMARY

The present disclosure provides a screen frame and a projection screen, which can solve the technical problem in the related art that the projection screen occupies a large space, resulting in great difficulty in transportation. The technical solutions of the screen frame and the projection screen are as follows.

In a first aspect, the present disclosure provides a screen frame. The screen frame has a bearing surface, and the screen frame includes two oppositely-arranged first foldable frame segments, two oppositely-arranged second foldable frame segments, and a third pivoting mechanism; wherein each of the first foldable frame segments includes two first frame sub-segments and a first pivoting mechanism, wherein first ends of the two first frame sub-segments are connected by the first pivoting mechanism, the first pivoting mechanism is configured to drive the two first frame sub-segments to fold or unfold around a first axis parallel to the bearing surface; each of the second foldable frame segments includes two second frame sub-segments, and at least one second foldable frame segment further includes a second pivoting mechanism, wherein the second pivoting mechanism is connected between first ends of two second frame sub-segments of one second foldable frame segment, and the second pivoting mechanism is configured to drive two corresponding second frame sub-segments to fold or unfold around a second axis intersecting the bearing surface; and the third pivoting mechanism is connected between a second end of a first frame sub-segment and a second end of a second frame sub-segment, and the third pivoting mechanism is configured to drive the second frame sub-segment to rotate relative to the first frame sub-segment around a fourth axis perpendicular to the bearing surface.

In a second aspect, the present disclosure provides a projection screen. The projection screen includes a screen frame and a flexible screen. The flexible screen conforms to a bearing surface of the screen frame, and the screen frame is the screen frame described in the first aspect.

### BRIEF DESCRIPTION OF THE DRAWINGS

FIG. 1 is a schematic structural diagram of a screen frame according to some embodiments of the present disclosure;

FIG. 2 is an effect diagram of a screen frame after folding according to some embodiments of the present disclosure;

FIG. 3 is an effect schematic diagram of a screen frame after folding according to some embodiments of the present disclosure;

FIG. 4 is a schematic structural diagram of another screen frame according to some embodiments of the present disclosure;

FIG. 5 is a schematic diagram of a connection between a second pivoting mechanism and a second frame sub-segment according to some embodiments of the present disclosure;

FIG. 6 is a schematic structural diagram of a second pivoting mechanism according to some embodiments of the present disclosure;

FIG. 7 is a schematic diagram of a rotation effect of the second pivoting mechanism shown in FIG. 6;

FIG. 8 is a schematic structural diagram of yet another screen frame according to some embodiments of the present disclosure;

FIG. 9 is a schematic diagram of a folding effect of the screen frame shown in FIG. 8;

FIG. 10 is a schematic structural diagram of a third pivoting mechanism according to some embodiments of the present disclosure;

FIG. 11 is a schematic structural diagram of a first pivoting mechanism according to some embodiments of the present disclosure;

FIG. 12 is a schematic diagram of a connection between a first frame sub-segment and a first pivoting mechanism according to some embodiments of the present disclosure;

FIG. 13 is a schematic structural diagram of a screen frame according to some embodiments of the present disclosure;

FIG. 14 is an effect diagram of a screen frame after folding according to some embodiments of the present disclosure;

FIG. 15 is a schematic structural diagram of another screen frame according to some embodiments of the present disclosure;

FIG. 16 is a schematic diagram of a screen frame after a first folding is completed according to some embodiments of the present disclosure;

FIG. 17 is a schematic diagram of a screen frame during a second folding process according to some embodiments of the present disclosure;

FIG. 18 is a schematic diagram of a screen frame after a second folding is completed according to some embodiments of the present disclosure;

FIG. 19 is a schematic diagram of a screen frame during a third folding process according to some embodiments of the present disclosure;

FIG. 20 is a schematic diagram of a screen frame after a third folding is completed according to some embodiments of the present disclosure;

FIG. 21 is a schematic structural diagram of a second pivoting mechanism according to some embodiments of the present disclosure;

FIG. 22 is a schematic diagram of a rotation effect of the second rotation structure shown in FIG. 21;

FIG. 23 is a schematic diagram of a folding effect of another screen frame according to some embodiments of the present disclosure;

FIG. 24 is a schematic diagram of a connection between a first frame sub-segment and a first limiting member according to some embodiments of the present disclosure;

FIG. 25 is a schematic diagram of a connection between a second frame sub-segment and a second limiting member according to some embodiments of the present disclosure;

FIG. 26 is a schematic diagram of a connection between another second limiting member and a second frame sub-segment according to some embodiments of the present disclosure;

FIG. 27 is a schematic diagram of the second limiting member shown in FIG. 26 after being connected to two second frame sub-segments;

FIG. 28 is a schematic diagram of a third rotation structure according to some embodiments of the present disclosure;

FIG. 29 is a schematic structural diagram of a first pivoting mechanism according to some embodiments of the present disclosure;

FIG. 30 is an exploded schematic diagram of a projection screen according to some embodiments of the present disclosure;

FIG. 31 is an exploded schematic diagram of a flexible screen according to some embodiments of the present disclosure;

FIG. 32 is an exploded schematic diagram of another projection screen according to some embodiments of the present disclosure;

FIG. 33 is a cross-sectional view of one frame sub-segment of a screen frame shown in FIG. 32;

FIG. 34 is an installation schematic diagram of a support rod according to some embodiments of the present disclosure;

FIG. 35 is an installation schematic diagram of a flexible screen with a screen frame according to some embodiments of the present disclosure;

FIG. 36 is a schematic structural diagram of a projection screen according to some embodiments of the present disclosure;

FIG. 37 is a schematic structural diagram of a portion of a projection screen according to some embodiments of the present disclosure;

FIG. 38 is a schematic diagram of a first pivoting mechanism in an unfolded state according to some embodiments of the present disclosure;

FIG. 39 is a schematic diagram of a first pivoting mechanism in a folded state according to some embodiments of the present disclosure;

FIG. 40 is a schematic diagram of a second pivoting mechanism switching from an unfolded state to a storage state according to some embodiments of the present disclosure;

FIG. 41 is a three-dimensional schematic diagram of a second pivoting mechanism switching from a locked state to an unlocked state according to some embodiments of the present disclosure;

FIG. 42 is a cross-sectional view of a second pivoting mechanism switching from a locked state to an unlocked state according to some embodiments of the present disclosure;

FIG. 43 is a schematic diagram of a process of vertical beam storage according to some embodiments of the present disclosure;

FIG. 44 is a schematic diagram of a process of folding a screen frame according to some embodiments of the present disclosure;

FIG. 45 is a schematic diagram of a position of a second limiting member and a vertical beam in an unfolded state of a screen frame according to some embodiments of the present disclosure;

FIG. 46 is a schematic diagram of a position of a second limiting member and a vertical beam during a folding process of a screen frame according to some embodiments of the present disclosure;

FIG. 47 is a schematic diagram of a screen frame according to some embodiments of the present disclosure;

FIG. 48 is a partially enlarged schematic view of portion A shown in FIG. 47;

FIG. 49 is a schematic diagram of a screen frame in a folded state according to some embodiments of the present disclosure;

FIG. 50 is a schematic diagram of a flexible screen and a support rod according to some embodiments of the present disclosure;

FIG. 51 is a schematic diagram of a screen frame with a flexible screen according to some embodiments of the present disclosure;

FIG. 52 is a cross-sectional view of the screen frame shown in FIG. 51 at position A-A according to some embodiments of the present disclosure; and

FIG. 53 is another cross-sectional view of the screen frame shown in FIG. 51 at position A-A according to some embodiments of the present disclosure.

### REFERENCE NUMERALS

00, projection screen; 000, screen frame; 001, flexible screen; D1, screen sheet; D2, flexible carrier; 002, support rod; 0021, rod body; 0022, locking strip; 003, angle iron; 0031, avoidance region; 004, locking screw; 100, first foldable frame segment; 101, first frame sub-segment; 102, first pivoting mechanism; 1021, leaf; 1022, rotation shaft; C1, rotation shaft body; C2, pin shaft; 103, first limiting member; 200, second foldable frame segment; 201, second frame sub-segment; 201a, second elastic protrusion; 202, second pivoting mechanism; 2021, adapter; 20211, mounting hole; 20212, locking groove; 2022, connecting member; 20221, sliding groove; 2023, first pivoting shaft; 2024, ejector; 2025, elastic member; 203, second limiting member; 203a, second slot; 300, third pivoting mechanism; 301, first fixing member; 302, second fixing member; 303, third pivoting shaft; 400, vertical beam; 401, first sub-beam; 402, second sub-beam; 410, accommodating groove; 420, fixing block; L1, first axis; L2, second axis; L3, third axis; L4, fourth axis; A, rectangular frame; A1, first frame; A2, second frame; B1, first sub-adapter; B2, second sub-adapter; B3, second pivoting shaft; B4, limit post; Q1, bearing cavity; Q11, first sub-bearing cavity; Q12, second sub-bearing cavity; Q2, notch groove; Q3, accommodation pocket; Q4, first sliding groove; Q5, second sliding groove; k1, opening; a1, connection hole; a2, limit sliding groove; a3, limiting recess; z1, mounting cavity.

### DETAILED DESCRIPTION

In the related art, a frame used to support a screen in a projection screen is typically composed of a plurality of frames and structural components for connecting these frames. However, the size of the projection screens is increasingly larger, resulting in the size of the frame also growing. If the frame is assembled and then transported to the user's residence, the transportation is difficult. If the various components of the frame are disassembled and then transported to the user's residence and then assembled, the user's assembly is complicated and time-consuming, which in turn leads to a poor user experience.

Referring to FIG. 1, FIG. 1 is a schematic structural diagram of a screen frame according to some embodiments of the present disclosure. The screen frame 000 has a bearing surface. The screen frame 000 includes two oppositely-arranged first foldable frame segments 100, two oppositely-arranged second foldable frame segments 200, and a third pivoting mechanism 300. The screen frame 000 is used to integrate into a projection screen 00, and after the screen frame 000 is flattened, the bearing surface of the screen frame 000 is a side for bearing a flexible screen (not shown in the figure) in the projection screen. FIG. 1 shows a rear view of the screen frame with the screen frame having a side ml arranged opposite to the bearing surface.

Each of the first foldable frame segments 100 in the screen frame 000 includes two first frame sub-segments 101 and a first pivoting mechanism 102 disposed between the two first frame sub-segments 101. The first ends of the two first frame sub-segments 101 are connected by the first pivoting mechanism 102, and the first pivoting mechanism 102 is used to drive the two first frame sub-segments 101 to fold or unfold around a first axis L1 parallel to the bearing surface of the screen frame 000.

Each of the second foldable frame segments 200 in the screen frame 000 includes two second frame sub-segments 201 and a second pivoting mechanism 202 disposed between the two second frame sub-segments 201. The first ends of the two second frame sub-segments 201 are connected by the second pivoting mechanism 202, and the second pivoting mechanism 202 is used to drive the two second frame sub-segments 201 to fold or unfold around a second axis L2 intersecting (e.g., perpendicular to) the bearing surface of the screen frame 000, and to drive the two second frame sub-segments 201 to rotate around a third axis L3 that is parallel to the bearing surface and perpendicular to the first axis L1.

The third pivoting mechanism 300 in the screen frame 000 is used to connect the second end of the first frame sub-segment 101 and the second end of the second frame sub-segment 201, and the third pivoting mechanism 300 is used to drive the second frame sub-segment 201 to rotate relative to the first frame sub-segment 101 around the fourth axis L4 perpendicular to the bearing surface of the screen frame 000. As shown in FIG. 1, the second end of the first frame sub-segment 101 and the second end of the second frame sub-segment 201 that are adjacent to each other are rotatably connected by the third pivoting mechanism 300.

In the embodiments of the present disclosure, the two oppositely-arranged first foldable frame segments 100 and the two oppositely-arranged second foldable frame segments 200 in the screen frame 000 are connected end to end to form a rectangular frame A. The rectangular frame A includes a first frame A1 and a second frame A2. One first frame sub-segment 101 in one first foldable frame segment 100, one first frame sub-segment 101 in the other first foldable frame segments 100, and one second foldable frame segment 200 disposed between the two first frame sub-segments 101 form the first frame A1. The other first frame sub-segment 101 in one first foldable frame segment 100, the other first frame sub-segment 101 in the other first foldable frame segment 100, and one second foldable frame segment 200 disposed between the two first frame sub-segments 101 form the second frame A2.

The first pivoting mechanism 102 is disposed between the first frame A1 and the second frame A2, and the first frame A1 and the second frame A2 can rotate relative to each other by the first pivoting mechanism 102 to form a folding frame. In addition, when the first frame A1 is rotated to a coplanar position relative to the second frame A2 by the first pivoting mechanism 102, the first frame A1 and the second frame A2 can form the rectangular frame A. For example, the two oppositely-arranged first foldable frame segments 100 are long border frames in the rectangular frame, and the two oppositely-arranged second foldable frame segments 200 are short border frames in the rectangular frame. Alternatively, the two oppositely-arranged first foldable frame segments 100 are short borders in the rectangular frame, and the two oppositely-arranged second foldable frame segments 200 are long borders in the rectangular frame.

It should be noted that all the embodiments of the present disclosure are schematically described by taking the two oppositely-arranged first foldable frame segments 100 as long border frames in the rectangular frame A, and the two oppositely-arranged second foldable frame segments 200 as short border frames in the rectangular frame A.

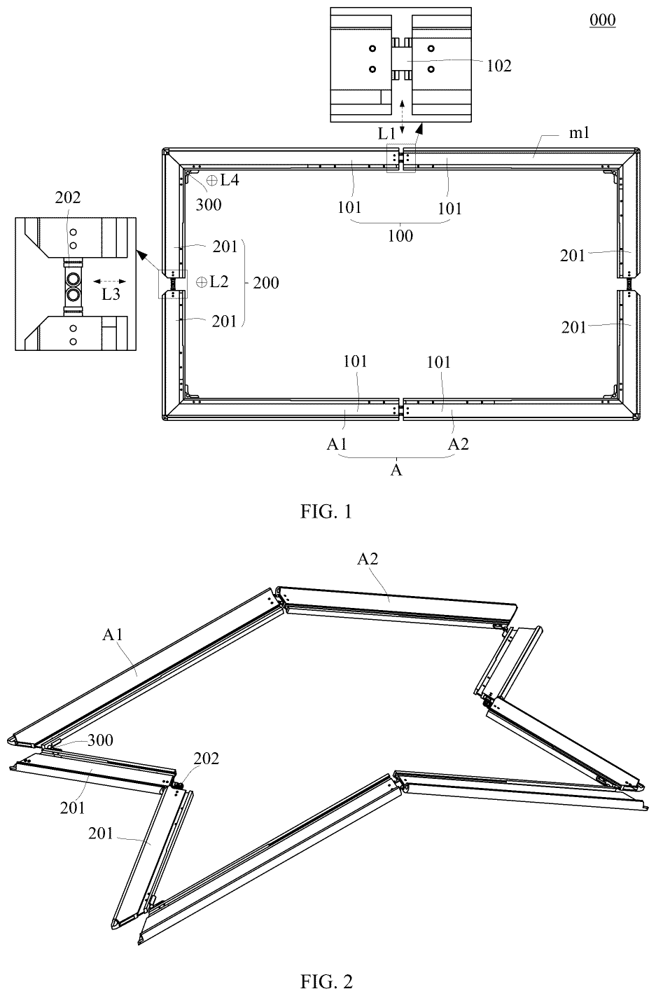

Referring to FIGS. 1 and 2, FIG. 2 is an effect diagram of a screen frame after folding according to some embodiments of the present disclosure. Two first frame sub-segments 101 in each first foldable frame segment 100 of the screen frame 000 can rotate around the first axis L1 for folding by the first pivoting mechanism 102, and two second frame sub-segments 201 in each second foldable frame segment 200 can rotate around the second axis L2 by the second pivoting mechanism 202 and can rotate relative to the first frame sub-segments 101 by the third pivoting mechanism 300.

In this way, the components in the screen frame 000 can be assembled to form an overall frame (i.e., a rectangular frame) before the screen frame 000 enters the user's residence. Afterwards, the two second frame sub-segments 201 are rotated relative to each other by the second pivoting mechanism 202 and rotated relative to the first frame sub-segment 101 by the third pivoting mechanism 300 to be folded. The folding can shorten the distance between the two first foldable frame segments 100, resulting in a smaller overall size of the rectangular frame. Then, the first frame A1 and the second frame A2 in the rectangular frame are rotated relative to each other by the first pivoting mechanism 102 to form a folding frame, which further reduces the overall size of the rectangular frame, and thus can effectively simplify the transportation of the screen frame 000.

In addition, after the screen frame 000 is transported to the user's residence, the two first frame sub-segments 101 can be unfolded to a certain extent by the first pivoting mechanism 102, the two second frame sub-segments 201 can be driven to unfold to a certain extent around the second axis L2 by the second pivoting mechanism 202, and then the two second frame sub-segments 201 can be driven to unfold to a certain extent around the third axis L3. The unfolded screen frame 000 is in a suitable state for assembling the flexible screen (e.g., the state shown in FIG. 32), facilitating the assembly of the flexible screen and the screen frame in the projection screen. After the flexible screen and the screen frame are assembled, the folded screen frame 000 continues to be flattened, and the flexible screen with a certain degree of elasticity can be driven to tension, and the final assembly of the screen frame 000 can be completed. In this way, it can effectively simplify the user's assembly process, save assembly time, and improve the user's experience.

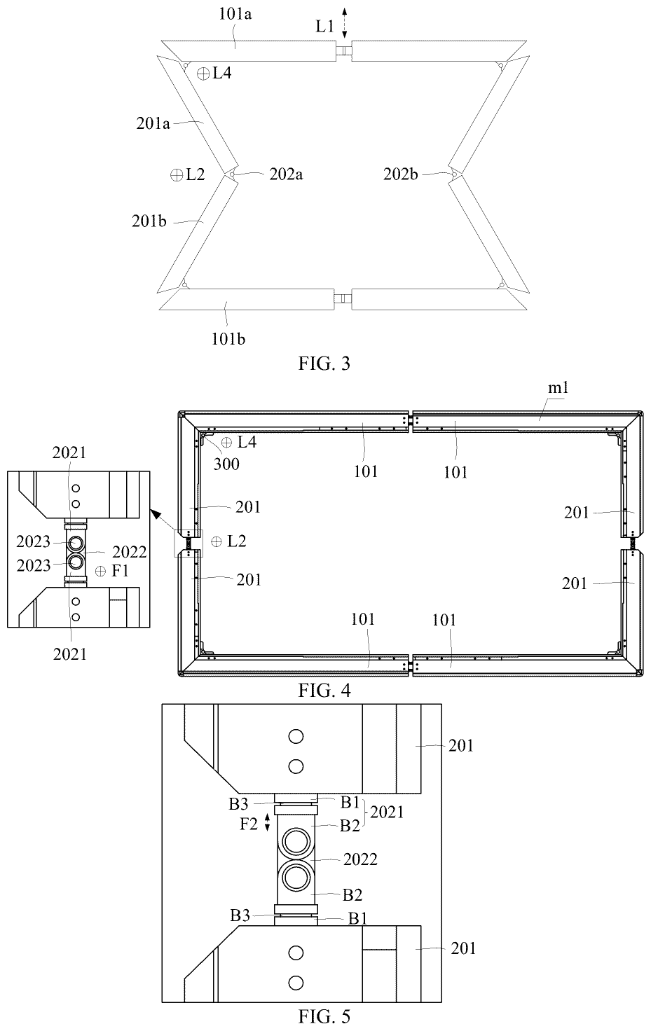

In one possible implementation, referring to FIG. 3, FIG. 3 is an effect schematic diagram of a screen frame after folding according to some embodiments of the present disclosure. After the second pivoting mechanism 202 drives the two second frame sub-segment 201 to fold, the two second frame sub-segment 201 are disposed between the two first foldable frame segments 100. In this way, it can be ensured that after the second foldable frame segment 200 in the screen frame 000 is folded, the length of the screen frame 000 (e.g., a rectangular frame) in the direction of the long border frame is not increased, making the distance between the two oppositely-arranged first foldable frame segments 100 decrease. In addition, after the second foldable frame segment 200 is folded, the user can further fold the two first frame sub-segments 101 in the first foldable frame segment 100 by the first pivoting mechanism 102, such that the overall volume of the finally folded screen frame 000 is relatively small.

In one possible implementation, as shown in FIG. 3, each of the two oppositely-arranged second foldable frame segments 200 includes a second pivoting mechanism 202. The two second pivoting mechanisms in the two second foldable frame segments 200 may be a second pivoting mechanism 202a and a second pivoting mechanism 202b, respectively. The first end of the second frame sub-segment 201a and the first end of the second frame sub-segment 201b in one second foldable frame segment are rotatably connected by the second pivoting mechanism 202a. In this way, when the second foldable frame segment 200 is folded, the second frame sub-segment 201a can be rotated counterclockwise around the first frame sub-segment 101a by the third pivoting mechanism 300, and the second frame sub-segment 201b can be rotated clockwise around the first frame sub-segment 101b by the third pivoting mechanism 300.

In one possible implementation, referring to FIG. 4, which is a schematic structural diagram of another screen frame according to some embodiments of the present disclosure. The second pivoting mechanism 202 in each second foldable frame segment 200 includes two adapters 2021 rotatably connected to the first ends of the two second frame sub-segments 201 respectively and a connecting member 2022 disposed between the two adapters 2021. An end portion of each adapter 2021 away from the second frame sub-segment 201 is rotatably connected to the connecting member 2022 by a first pivoting shaft 2023.

The two adapters 2021 in the second pivoting mechanism 202 are configured to rotate synchronously between the two second frame sub-segments 201, such that the center axis F1 of the first pivoting shaft 2023 is parallel to the second axis L2, or, the center axis F1 of the first pivoting shaft 2023 is parallel to the third axis L3.

In this way, the two second frame sub-segments 201 can be rotated relative to each other. Moreover, by rotationally connecting the adapter 2021 to the first end of the second frame sub-segment 201, synchronized rotation of the two adapters 2021 between the two second frame sub-segments 201 is achieved (e.g., rotation of one full circle relative to the second frame sub-segments). Exemplarily, when the second frame sub-segment 201a and the second frame sub-segment 201b are folded inward simultaneously (i.e., the second frame sub-segment 201a and the second frame sub-segment 201b are located between the two first foldable frame segments after being folded), one adapter 2021 can be rotated counterclockwise around the first pivoting shaft 2023 relative to the connecting member 2022, and the other adapter 2021 can be rotated clockwise around the other first pivoting shaft 2023 relative to the connecting member 2022.

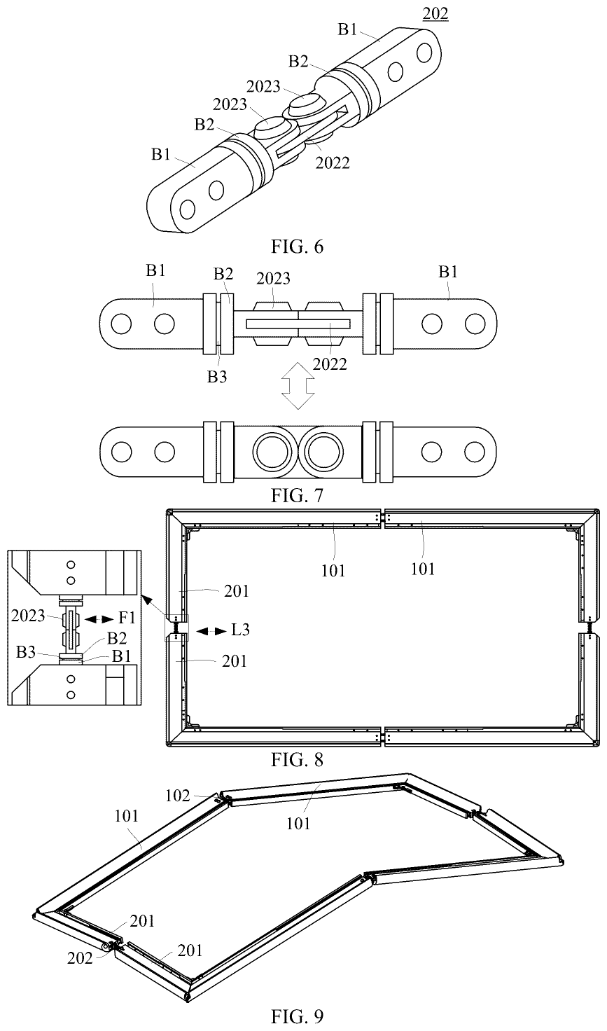

In one possible implementation, referring to FIG. 5, FIG. 6, and FIG. 7, FIG. 5 is a schematic diagram of a connection between a second pivoting mechanism and a second frame sub-segment according to some embodiments of the present disclosure, FIG. 6 is a schematic structural diagram of a second pivoting mechanism according to some embodiments of the present disclosure, and FIG. 7 is a schematic diagram of a rotation effect of the second pivoting mechanism shown in FIG. 6. Each adapter 2021 in the second pivoting mechanism 202 includes a first sub-adapter B1 fixedly connected to the first end of the second frame sub-segment 201, a second sub-adapter B2 rotatably connected to the connecting member 2022 (the second sub-adapter B2 is rotatably connected to the connecting member 2022 by a first pivoting shaft 2023), and a second pivoting shaft disposed between the first sub-adapter B1 and the second sub-adapter B2. The second pivoting shaft B3 is rotatably connected to the first sub-adapter B1 and the second sub-adapter B2 respectively, and an center axis F2 of the second pivoting shaft B3 is perpendicular to the center axis F1 of the first pivoting shaft 2023.

In this way, referring to FIGS. 8 and 9, FIG. 8 is a schematic structural diagram of yet another screen frame according to some embodiments of the present disclosure, and FIG. 9 is a schematic diagram of a folding effect of the screen frame shown in FIG. 8. In the actual use of the screen frame 000, the two second frame sub-segments 201 in each second foldable frame segment 200 can be folded through the interaction among the adapter 2021, the first pivoting shaft 2023, and the connecting member 2022. After folding, the volume of the screen frame 000 can be effectively reduced, which is convenient for transporting it to the user. After the folded screen frame 000 enters the user's residence, the user can rotate the interconnected second sub-adapter B2, the first spindle 2023, and the connecting member 2022 by a certain angle (e.g., 90 degrees) relative to the first sub-adapter B1 by the second pivoting shaft B3. Then, each adapter 2021 rotates relative to the connecting member 2022 by the first pivoting shaft 2023, causing the two second frame sub-segments 201 in the second foldable frame segment 200 to be integrally folded in a direction perpendicular to the bearing surface of the screen frame 000.

It should be noted that after being rotated by the interconnected second sub-adapter B2, the first pivoting shaft 2023, and the connecting member 2022 by a certain angle (e.g., 90 degrees) relative to the first sub-adapter B1 (e.g., as shown in the state of FIG. 8) via the second pivoting shaft B3, the second frame sub-segment 201 is then rotated relative to the connecting member 2022 through the adapter 2021 using the first pivoting shaft 2023 to be folded. The folded screen frame 000 is in a suitable state for assembling the flexible screen (e.g., the state shown in FIG. 32), facilitating the assembly of the flexible screen and the screen frame in the projection screen. Moreover, after the flexible screen and the screen frame are assembled, the folded screen frame 000 can be flattened to drive the flexible screen with a certain elasticity to be tensioned. It should also be noted that the structures and movement principles of the two adapters 2021 in the second pivoting mechanism 202 are the same, and will not be repeated here.

In one possible implementation, the second pivoting mechanism 202 may also be implemented in the manner shown in FIGS. 21 and 22.

In another possible implementation, the second pivoting mechanism 202 may also not be used to drive the two second frame sub-segments 201 around the third axis L3 that is parallel to the bearing surface and perpendicular to the first axis L1. Then, for this case, the two adapters 2021 included in the second pivoting mechanism 202 may be fixedly connected to the first ends of the two second frame sub-segments 201, for example, the second pivoting mechanism 202 is realized in the manner shown in FIG. 40 to FIG. 42.

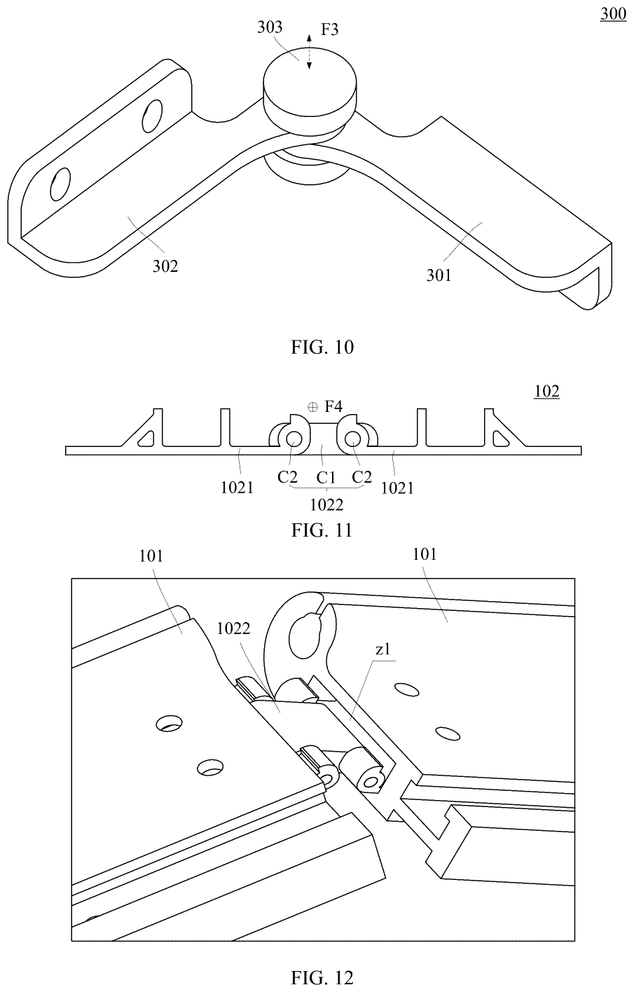

In one possible implementation, referring to FIGS. 1 and 10, FIG. 10 is a schematic structural diagram of a third pivoting mechanism according to some embodiments of the present disclosure. The third pivoting mechanism 300 in the screen frame 000 includes a first fixing member 301 and a second fixing member 302, and a third pivoting shaft 303 rotatably connected to the first fixing member 301 and the second fixing member 302, respectively. The first fixing member 301 is fixedly connected to the second end of one first frame sub-segment 101, and the second fixing member 302 is fixedly connected to the second end of one second frame sub-segment 201. The center axis F3 of the third pivoting shaft 303 in the third pivoting mechanism 300 is perpendicular to the bearing surface of the screen frame 000 (i.e., the center axis F3 of the third pivoting shaft 303 is parallel to the fourth axis L4).

In this way, when the second foldable frame segment 200 is folded, for two adjacently arranged first frame sub-segments 101 and second frame sub-segment 201, the second frame sub-segment 201 can be rotated relative to the first frame sub-segments 101 by the third pivoting shaft 303. In the embodiments of the present disclosure, the two oppositely-arranged first foldable frame segments 100 and the two oppositely-arranged second foldable frame segments 200 usually need four third pivoting mechanisms 300 for connection. The four third pivoting mechanisms 300 are disposed in a region enclosed by the flattened screen frame 000 (i.e., a rectangular frame). In this way, after the bearing surface of the screen frame 000 bears the flexible screen, the appearance effect of the projection screen will not be affected. It should be noted that, in addition to the structure described above, the third pivoting mechanism 300 may also adopt other structures, which are not specifically limited in the embodiments of the present disclosure.

In one possible implementation, referring to FIGS. 1 and 11, FIG. 11 is a schematic structural diagram of a first pivoting mechanism according to some embodiments of the present disclosure. The first pivoting mechanism 102 includes two leaves 1021 fixedly connected to the first ends of the two first frame sub-segments 101, respectively, and a rotation shaft 1022 disposed between the two leaves 1021 and rotatably connected to the two leaves 1021, respectively. The two leaves 1021 are rotatably connected relative to each other by the rotation shaft 1022. An center axis F4 of the rotation shaft 1022 is parallel to the first axis L1. In this way, the two first frame sub-segments 101 can be rotated relative to each other under the action of the two leaves 1021 and the rotation shaft 1022.

In one possible implementation, as shown in FIG. 11, the rotation shaft 1022 in the first pivoting mechanism 102 includes a rotation shaft body C1 and pin shafts C2 that are rotatably connected to the two leaves 1021 respectively. The leaves 1021 are rotatably connected to the rotation shaft body C1 via the pin shafts C2. An center axis of each pin shaft C2 is parallel to the first center axis L1.

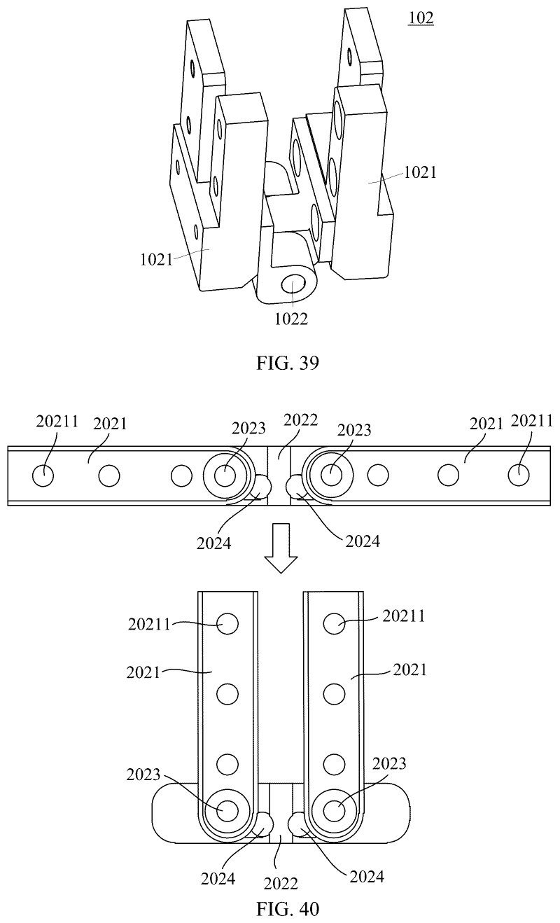

In another possible implementation, the first pivoting mechanism 102 may also adopt the structure shown in FIGS. 38 and 39.

In one possible implementation, referring to FIG. 12, FIG. 12 is a schematic diagram of a connection between a first frame sub-segment and a first pivoting mechanism according to some embodiments of the present disclosure. Each of the two first frame sub-segments 101 in each first foldable frame segment is provided with a mounting cavity z1, two leaves 1021 in the first pivoting mechanism 102 are fixed in the two mounting cavities z1, and a rotation shaft 1022 is located between the first ends of the two first frame sub-segments 101.

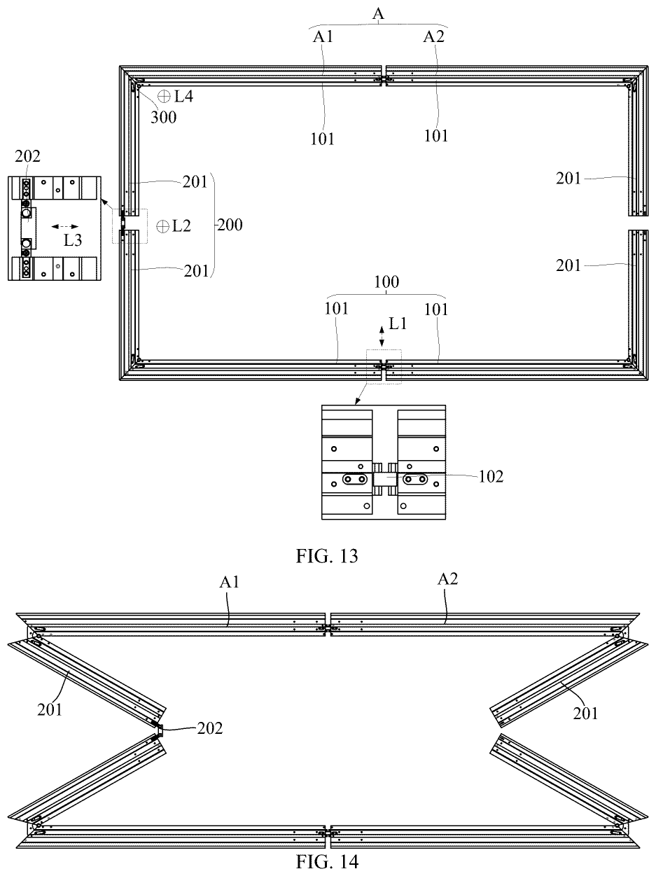

The embodiments of the present disclosure also provide a screen frame, referring to FIG. 13, FIG. 13 is a schematic structural diagram of a screen frame according to some embodiments of the present disclosure. The screen frame 000 has a bearing surface, and the screen frame 000 includes two oppositely-arranged first folding edges 100, two oppositely-arranged second folding edges 200, and a third pivoting mechanism 300. The screen frame 000 is integrated into a projection screen 00, and after the screen frame 000 is flattened, the bearing surface of the screen frame 000 is a surface for bearing a flexible screen (not shown in the figure) in the projection screen.

Each first foldable frame segment 100 includes two first frame sub-segments 101 and a first pivoting mechanism 102 disposed between the two first frame sub-segments 101. The first ends of the two first frame sub-segments 101 are connected by the first pivoting mechanism 102, and the first pivoting mechanism 102 is used to drive the two first frame sub-segments 101 to fold or unfold around a first axis L1 parallel to the bearing surface of the screen frame.

Each second foldable frame segment 200 includes two second frame sub-segments 201, the first ends of the two second frame sub-segments 201 in one second foldable frame segment 200 are connected by a second pivoting mechanism 202, and the first ends of the two second frame sub-segments 201 in the other second foldable frame segment 200 are separated. The second pivoting mechanism 202 is used to drive the two second frame sub-segments 201 in the one second foldable frame segment 200 to fold or unfold around a second axis L2 intersecting the bearing surface of the screen frame, and is used to drive the two second frame sub-segments 201 in the one second foldable frame segment 200 to rotate around a third axis L3 parallel to the bearing surface of the screen frame and perpendicular to the first axis L1.

The third pivoting mechanism 300 is used to drive the second frame sub-segment 201 to rotate relative to the first frame sub-segment 101 around the fourth axis L4 perpendicular to the bearing surface of the screen frame. The second end of the first frame sub-segment 101 and the second end of the second frame sub-segment 201, which are adjacently arranged, can be rotatably connected by the third pivoting mechanism 300.

In the technical solution according to some embodiments of the present disclosure, two oppositely-arranged first foldable frame segments 100 and two oppositely-arranged second foldable frame segments 200 in the screen frame 000 are connected in turn to form a rectangular frame A. The rectangular frame A includes a first frame A1 and a second frame A2. One first frame sub-segment 101 in one first foldable frame segment 100 and one first frame sub-segment 101 in the other first foldable frame segment 100, and one second foldable frame segment 200 disposed between the two first frame sub-segments 101 form the first frame A1. The other first frame sub-segment 101 of one first foldable frame segment 100 and the other first frame sub-segment 101 of the other first foldable frame segment 100, and one second foldable frame segment 200 disposed between the two first frame sub-segments 101 include the second frame A1. The first pivoting mechanism 102 is disposed between the first frame A1 and the second frame A2, and the first frame A1 and the second frame A2 can be rotated relative to each other by the first pivoting mechanism 102 to form the folding frame.

In addition, when the first frame A1 is rotated to a coplanar position relative to the second frame A2 by the first pivoting mechanism 102, the first frame A1 and the second frame A2 can form the rectangular frame A. For example, the two oppositely-arranged first foldable frame segments 100 may be long border frames in the rectangular frame, and the two oppositely-arranged second foldable frame segments 200 may be short border frames in the rectangular frame. Alternatively, the two oppositely-arranged first foldable frame segments 100 may be short border frames in the rectangular frame, and the two oppositely-arranged second foldable frame segments 200 may be long border frames in the rectangular frame.

It should be noted that all the embodiments of the present disclosure are schematically described by taking the two oppositely-arranged first foldable frame segments 100 as long border frames in a rectangular frame and the oppositely-arranged two second foldable frame segments 200 as short border frames in the rectangular frame.

In one possible implementation, refer to FIG. 13 and FIG. 14, FIG. 14 is an effect diagram of a screen frame after folding according to some embodiments of the present disclosure. Two first frame sub-segments 101 in each first foldable frame segment 100 can be rotated around a first axis L1 for folding by the first pivoting mechanism 102, and two second frame sub-segments 201 in one second foldable frame segment 200 can be rotated around a second axis L2 by a second pivoting mechanism 202 and rotated relative to the first frame sub-segments 101 by the third pivoting mechanism 300.

In this way, the components in the screen frame can be assembled to form an overall frame (i.e., a rectangular frame) before the screen frame enters the user's residence. In the folding process, first, the two second frame sub-segments 201 are rotated relative to each other by the second pivoting mechanism 202, and are folded after being rotated relative to the first frame sub-segment 101 by the third pivoting mechanism 300. After folding, the distance between the two first foldable frame segments 100 can be shortened, making the overall size of the rectangular frame smaller. Then, the first frame A1 and the second frame A2 in the rectangular frame are rotated relative to each other by the first pivoting mechanism 102 to form the folding frame, further reducing the overall size of the rectangular frame. Moreover, after the second foldable frame segment 200 is folded between the two first foldable frame segments 100, and the first foldable frame segment 100 is then folded by the first pivoting mechanism 102, the first ends of the two second frame sub-segments 201 in the other second foldable frame segment 200 are separated. Therefore, as shown in FIGS. 18-FIG. 20, the second pivoting mechanism 202 can further drive the second sub-foldable frame segment 201 to rotate around the third axis L3 for folding, such that the overall size of the rectangular frame is further reduced after folding, which in turn can effectively simplify the transportation of the screen frame. After the screen frame is integrated in the projection screen, the transportation difficulty of the projection screen can be effectively simplified.

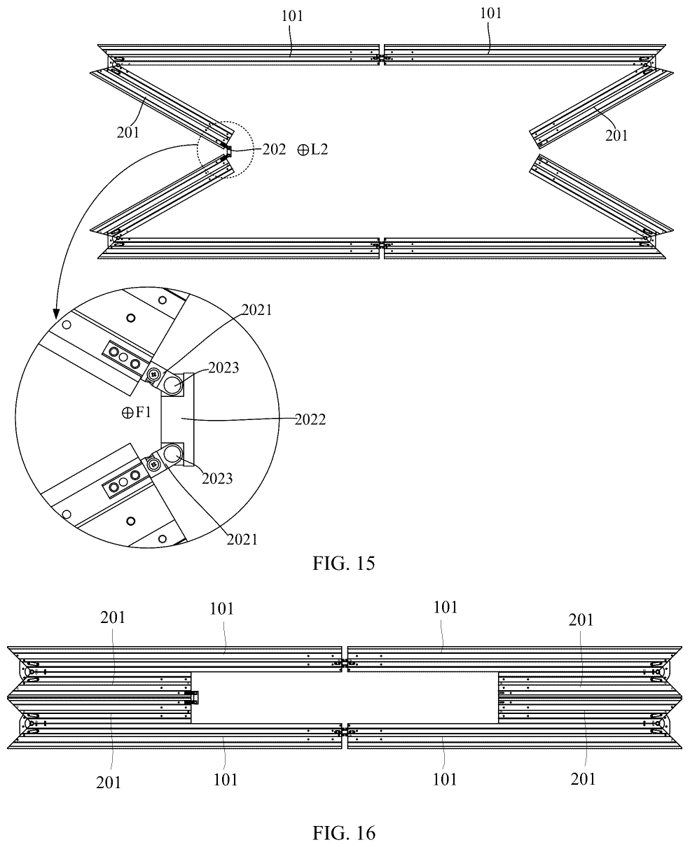

In one possible implementation, referring to FIG. 15, FIG. 15 is a schematic structural diagram of another screen frame according to some embodiments of the present disclosure. The second pivoting mechanism 202 includes two adapters 2021 rotatably connected to the first ends of the two second frame sub-segments 201 in the second foldable frame segment 200 respectively, and a connecting member 2022 disposed between the two adapters 2021. The end portion of each adapter 2021 away from the second frame sub-segment 201 is rotatably connected to the connecting member 2022 by the first pivoting shaft 2023. When the center axis F1 of the first pivoting shaft 2023 is parallel to the second axis L2, the two adapters 2021 can drive the two second frame sub-segments 201 to fold or unfold around the second axis L2, and after the two adapters 2021 drive the two second frame sub-segments 201 to fold around the second axis L2, the center axis of the adapter 2021 can be parallel to the third axis L3, and each adapter 2021 can be rotated itself around the center axis of the adapter 2021 relative to the connecting member 2022.

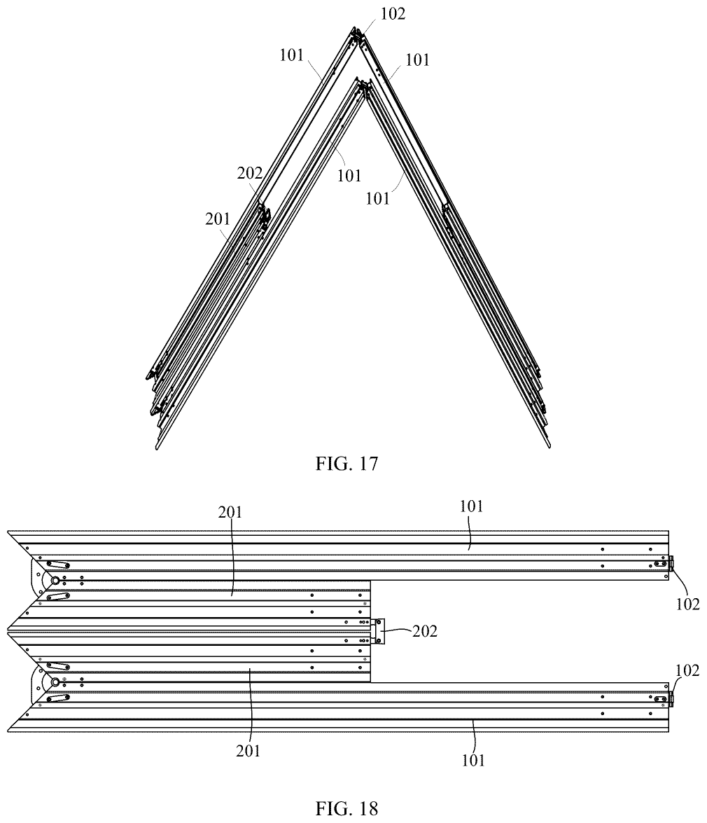

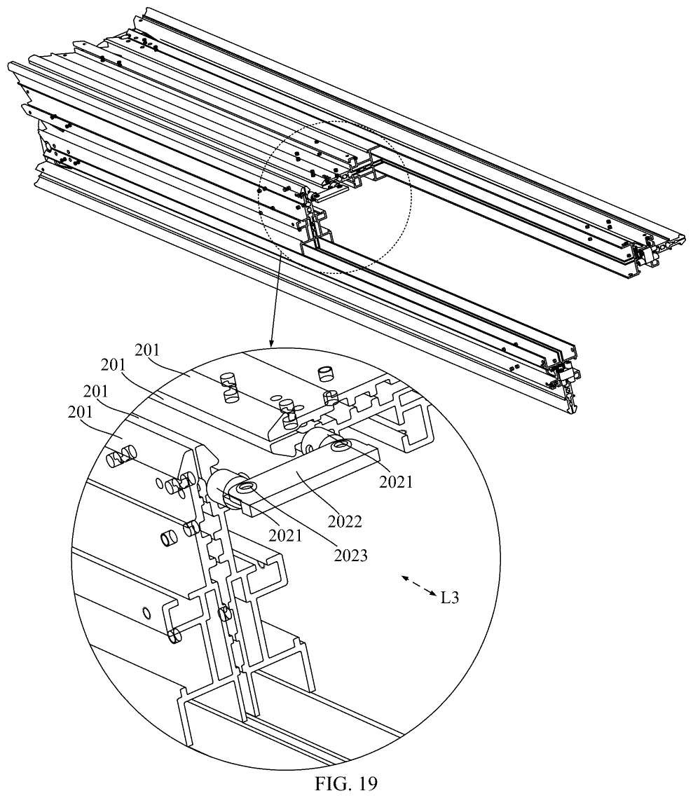

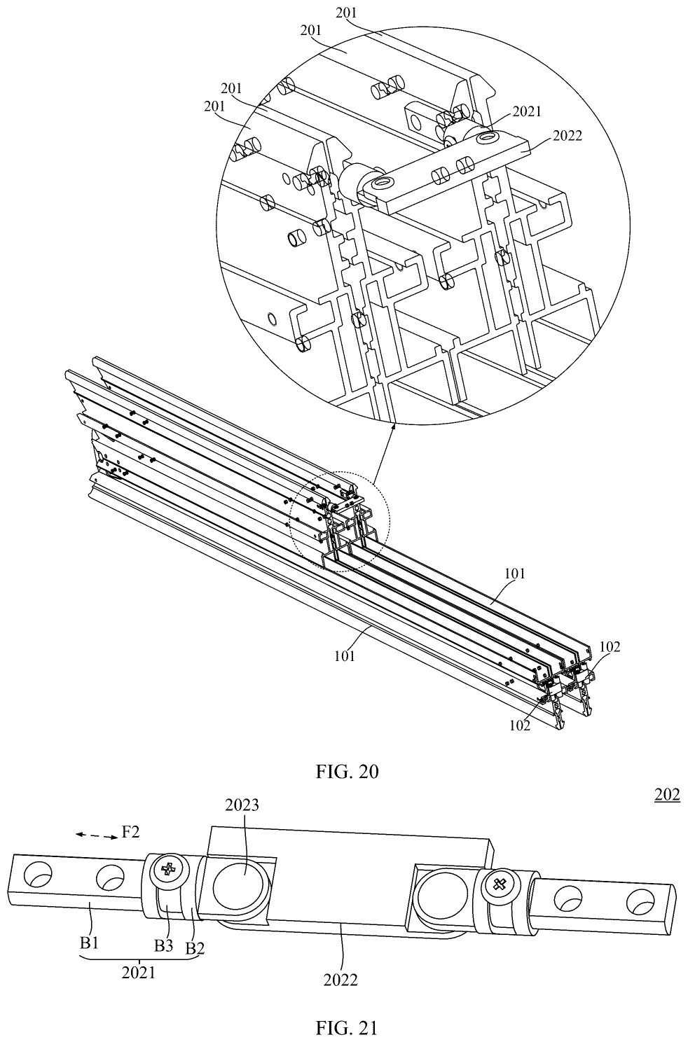

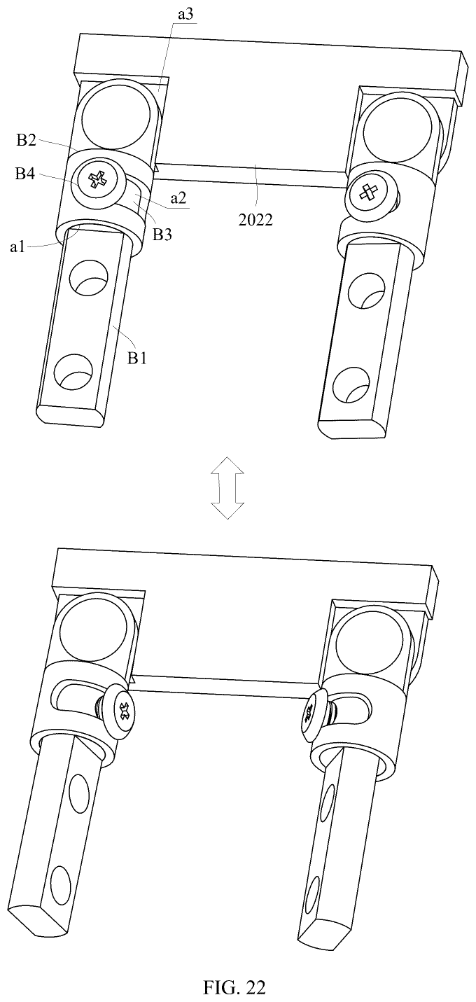

Referring to FIG. 16, FIG. 17, FIG. 18, FIG. 19, and FIG. 20, FIG. 16 is a schematic diagram of a screen frame after a first folding is completed according to some embodiments of the present disclosure, FIG. 17 is a schematic diagram of a screen frame during a second folding process according to some embodiments of the present disclosure, FIG. 18 is a schematic diagram of a screen frame after a second folding is completed according to some embodiments of the present disclosure, FIG. 19 is a schematic diagram of a screen frame during a third folding process according to some embodiments of the present disclosure, and FIG. 20 is a schematic diagram of a screen frame after a third folding is completed according to some embodiments of the present disclosure. When the screen frame is being folded, the two adapters 201 can drive the two second frame sub-segments 201 in one second foldable frame segment 200 to be folded around the second axis L2 (during which the adapters are rotated relative to the connecting member via the first pivoting shaft). Moreover, after the two second frame sub-segments 201 are folded to a final state (the length direction of the two second frame sub-segments is parallel to the second axis L2), the two first frame sub-segments 101 in each first foldable frame segment 100 can be folded around the first axis L1 driven by the first pivoting mechanism 102, and after the two first frame sub-segments 101 are folded to a final state (the two first frame sub-segments are stacked), each adapter 2021 can also rotate itself relative to the connecting member 2022 around the center axis of the adapter 2021 to enable the adapter 2021 to drive the second frame sub-segment 201 connected to the adapter 2021 to rotate around the third axis L3 for folding.

It should be noted that the first ends of the two second frame sub-segments 201 in the other second foldable frame segment 200 are separated. Therefore, during the rotation of the two second frame sub-segments 201 in one second foldable frame segment 200 around the third axis L3 respectively, that is, the two second frame sub-segments 201 in the other second foldable frame segment 200 can also be driven to rotate around the third axis L3, which in turn enables the screen frame to be further folded.

In one possible implementation, referring to FIG. 21 and FIG. 22, FIG. 21 is a schematic structural diagram of a second pivoting mechanism according to some embodiments of the present disclosure, and FIG. 22 is a schematic diagram of a rotation effect of the second rotation structure shown in FIG. 21. The adapter 2021 in the second pivoting mechanism 202 includes a first sub-adapter B1 fixedly connected to a first end of the second frame sub-segment 201, a second sub-adapter B2 rotatably connected to the connecting member 2022, and a second pivoting shaft B3 disposed between the first sub-adapter B1 and the second sub-adapter B2. An end of the second pivoting shaft B3 is fixedly connected to an end portion of the first sub-adapter B1 away from the second frame sub-segment 201, the other end of the second pivoting shaft B3 is rotatably connected to the second sub-adapter B2, and an center axis of the second pivoting shaft B3 is perpendicular to an center axis of the first pivoting shaft 2023. Exemplarily, as shown in FIGS. 8 and 9, the first sub-adapter B1 can be rotated relative to the second sub-adapter B2 via the second pivoting shaft B3 to rotate the second frame sub-segment 201 around the third axis L3.

In one possible implementation, as shown in FIGS. 21 and 22, an end portion of the second sub-adapter B2 in the adapter 2021 close to the second pivoting shaft B3 is provided with a connection hole a1, and a sidewall of the second sub-adapter B2 is provided with a limit sliding groove a2 connected to the connection hole a1, and at least a portion of the second pivoting shaft B3 is disposed within the connection hole a1 on the second sub-adapter B2. The adapter 2021 also includes a limit post B4, one end of the limit post B4 passing through the limit sliding groove a2 on the side wall of the second sub-adapter B2 and then being fixedly connected to the second pivoting shaft B3. The first sub-adapter B1 is rotatably connected to the second sub-adapter B2 through the cooperation of the second pivoting shaft B3 and the connection hole a1, and the first sub-adapter B1 can be limited by the abutment of the limit post B4 against both ends of the limit sliding groove a2 after rotating to the target position relative to the second sub-adapter B2. In this way, the operational convenience for an operator during the folding or unfolding process of the screen frame is improved.

In one possible implementation, as shown in FIG. 22, the limit sliding groove a2 is an arc-shaped sliding groove, and an arc angle corresponding to the arc-shaped sliding groove can be greater than 0 degrees and less than or equal to 90 degrees.

In one possible implementation, as shown in FIG. 22, an end portion of the connecting member 2022 in the second pivoting mechanism 202 close to the adapter 2021 is provided with a limiting recess a3, and the second sub-adapter B2 is rotatably connected to the connecting member 2022 via the first pivoting shaft 2023 within the limiting recess a3. In this way, after the two second frame sub-segments 201 in one second foldable frame segment 200 are unfolded, the second sub-transfer member B2 can be abutted against the sidewall of the limiting recess a3 to limit the two second frame sub-segments 201 in this position.

In the technical solution according to some embodiments of the present disclosure, after the two adapters 2021 in the second pivoting mechanism 202 drive the two second frame sub-segments 201 to unfold around the second axis L2, the two adapters 2021 can synchronously rotate between the two second frame sub-segments 201 in one second foldable frame segment 200, as shown in FIG. 15, such that the center axis F1 of the first pivoting shaft 2023 is perpendicular to the second axis L2, or, such that the center axis F1 of the first pivoting shaft 2023 is parallel to the third axis L3.

In this way, one adapter 2021 and the connecting member 2022 are rotated by the first pivoting shaft 2023, and the other adapter 2021 and the connecting member 2022 are also rotated by the first pivoting shaft 2023, as well as under the action of the third pivoting mechanism 300, i.e., the two second frame sub-segments 201 can be rotated relative to each other. Moreover, through the rotational connection between the adapter 2021 and the first end of the second frame sub-segment 201, synchronous rotation of the two adapters 2021 between the two second frame sub-segments 201 is achieved (e.g., rotated by 90 degrees relative to the second frame sub-segment).

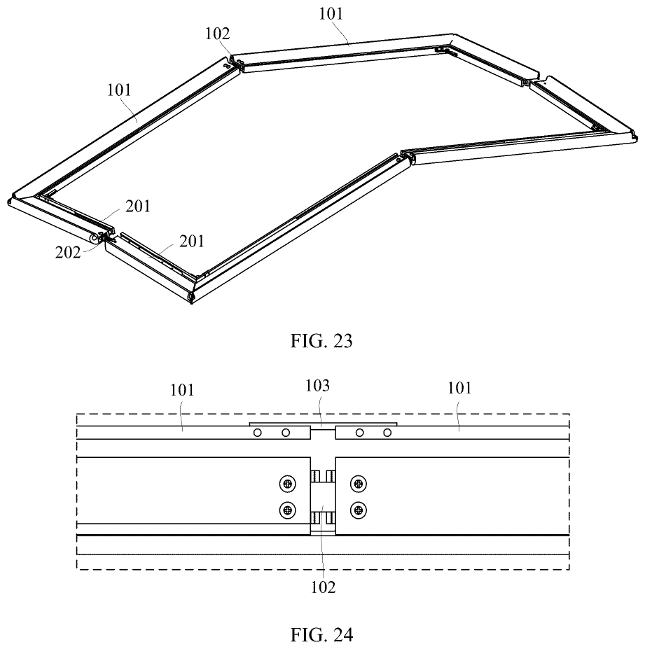

Referring to FIG. 23, FIG. 23 is a schematic diagram of a folding effect of another screen frame according to some embodiments of the present disclosure. In the actual use of the screen frame 000, two second frame sub-segments 201 in one second foldable frame segment 200 may be folded through the interaction of the adapter 2021, the first pivoting shaft 2023, the connecting member 2022, and the third pivoting mechanism 300; and two second frame sub-segments 201 in another second foldable frame segment 200 may be folded through the third pivoting mechanism 300. After folding, it can effectively reduce the volume of the screen frame 000, facilitating transportation to users.

After the folded screen frame 000 is brought into the user's residence, the user can rotate the interconnected second sub-adapter B2, the first pivoting shaft 2023, and the connecting member 2022 by a certain angle (e.g., 90 degrees) relative to the first sub-adapter B1 via the second pivoting shaft B3. Subsequently, each adapter 2021 is rotated relative to the connecting member 2022 via the first pivoting shaft 2023, such that the two second frame sub-segments 201 in the second foldable frame segment 200 can be folded integrally in a direction perpendicular to the bearing surface of the screen frame 000. The folded screen frame 000 is enabled to be in a suitable state for assembling the flexible screen, facilitating the assembly of the flexible screen and the screen frame in the projection screen. Moreover, after the flexible screen and the screen frame are assembled, the folded screen frame 000 can be flattened to drive the flexible screen with a certain elasticity to be tensioned. The structures and movement principles of the two adapters 2021 in the second pivoting mechanism 202 are the same, and will not be repeated here.

In one possible implementation, the second pivoting mechanism 202 may also be implemented in the manner shown in FIGS. 6 and 7.

In another possible implementation, the second pivoting mechanism 202 may also not be used to drive the two second frame sub-segments 201 around the third axis L3 that is parallel to the bearing surface and perpendicular to the first axis L1. Then, for this case, the two adapters 2021 included in the second pivoting mechanism 202 may be fixedly connected to the first ends of the two second frame sub-segments 201, for example, the second pivoting mechanism 202 is realized in the manner shown in FIG. 40 to FIG. 42.

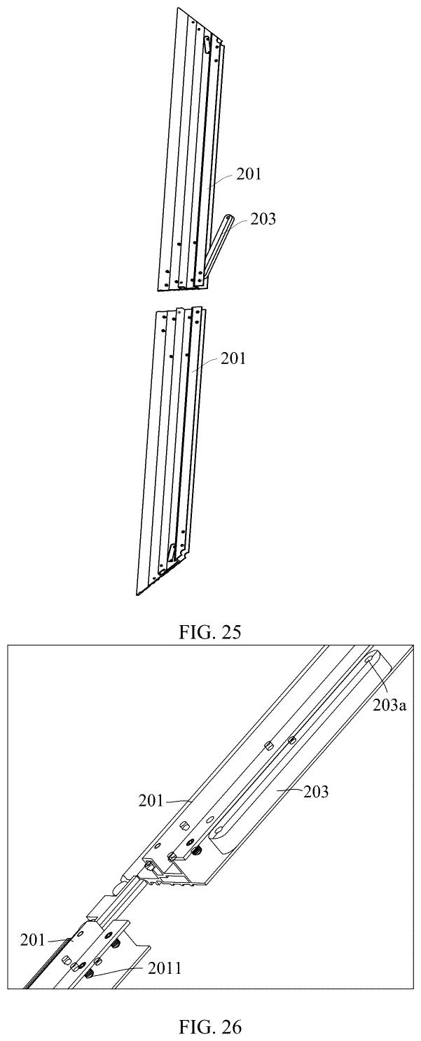

In one possible implementation, referring to FIG. 24 and FIG. 25, FIG. 24 is a schematic diagram of a connection between a first frame sub-segment and a first limiting member according to some embodiments of the present disclosure, and FIG. 25 is a schematic diagram of a connection between a second frame sub-segment and a second limiting member according to some embodiments of the present disclosure. Each first foldable frame segment 100 in the screen frame also includes a first limiting member 103. The first limiting member 103 is rotatably connected to a first end of one first frame sub-segment 101 in each first foldable frame segment 100 and detachably connected to a first end of the other first frame sub-segment 101. And/or, each second foldable frame segment 200 in the screen frame also includes a second limiting member 203. The second limiting member 203 is rotatably connected to a first end of one second frame sub-segment 201 of each second foldable frame segment 200, and detachably connected to a first end of the other second frame sub-segment 201.

It should be noted that the embodiments of the present disclosure are schematically described by taking each first foldable frame segment 100 including a first limiting member 103 and each second foldable frame segment 200 including a second limiting member 203 as an example. Taking the first limiting member 103 as an example, after the two first sub-foldable frame segments 101 are unfolded, the first limiting member 103 is rotated relative to one first frame sub-segment 101 to the other first frame sub-segment 101. The first limiting member 103 is used to limit the two first sub-foldable frame segments 101 to a coplanar position to prevent relative rotation between the two first frame sub-segments 101. When the screen frame needs to be folded, the first limiting member 103 can be separated from one of the first frame sub-segments 101, such that the two first frame sub-segments 101 can be rotated relative to the first pivoting mechanism 102. The working principle of the second limiting member 203 is the same as that of the first limiting member 103, and will not be repeated herein.

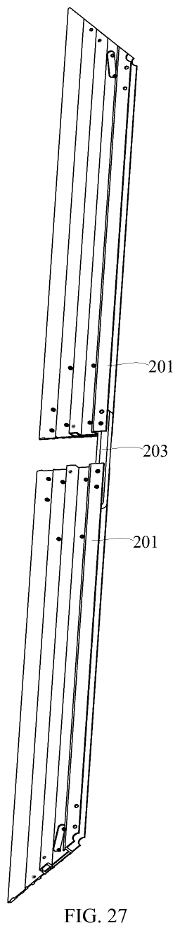

In one possible implementation, referring to FIG. 26 and FIG. 27, FIG. 26 is a schematic diagram of a connection between another second limiting member and a second frame sub-segment according to some embodiments of the present disclosure, and FIG. 27 is a schematic diagram of the second limiting member shown in FIG. 26 after being connected to two second frame sub-segments. The first end of the first frame sub-segment 101, which is detachably connected to the first limiting member 103, is provided with a first elastic protrusion (not shown in the figure), and the first limiting member 103 is provided with a first slot (not shown in the figure) that mates with the first elastic protrusion. And/or, the first end of the second frame sub-segment 201, which is detachably connected to the second limiting member 203, is provided with a second elastic protrusion 2011, and the second limiting member 203 is provided with a second slot 203a that mates with the second elastic protrusion 2011.

It should be noted that the embodiments of the present disclosure are schematically described by taking the first frame sub-segment 101 and the second frame sub-segment 201 both having elastic protrusions as an example. Taking the second elastic protrusion portion 2011 as an example, after the second limiting member 203 rotatably connected to one second frame sub-segment 201 is rotated to the other second frame sub-segment 201, the second slot 203a on the second limiting member 203 can be engaged with the second elastic protrusion 2011 to achieve the limiting of the two second frame sub-segments 201 by the second limiting member 203. The working principle of the first elastic protrusion and the first slot is the same as that of the second elastic protrusion 2011 and the second slot 203a, and will not be repeated herein.

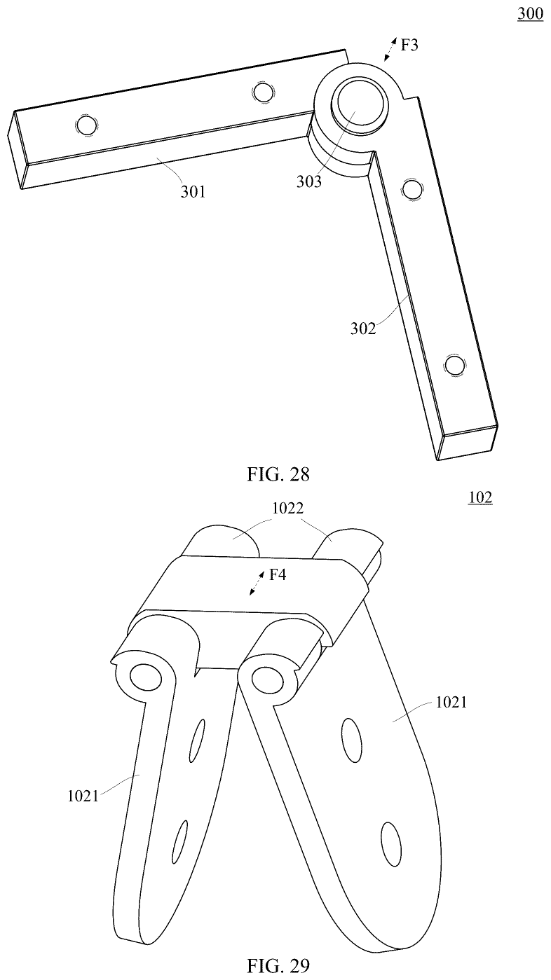

In one possible implementation, referring to FIG. 28, FIG. 28 is a schematic diagram of a third rotation structure according to some embodiments of the present disclosure. The third pivoting mechanism 300 in the screen frame 000 includes a first fixing member 301 and a second fixing member 302, and a third pivoting shaft 303 rotatably connected to the first fixing member 301 and the second fixing member 302, respectively. The first fixing member 301 is fixedly connected to a second end of one first frame sub-segment 101, and the second fixing member 302 is fixedly connected to a second end of one second frame sub-segment 201. The center axis F3 of the third pivoting shaft 303 in the third pivoting mechanism 300 is perpendicular to the bearing surface of the screen frame 000 (i.e., the center axis F3 of the third pivoting shaft 303 is parallel to the fourth axis L4). In this way, when the second foldable frame segment is folded, the two adjacently arranged first frame sub-segment 101 and second frame sub-segment 201 can be rotated relative to the first frame sub-segment 101 via the third pivoting shaft 303.

The two oppositely-arranged first foldable frame segments 100 and the two oppositely-arranged second foldable frame segments 200 usually need four third pivoting mechanisms 300 to be connected, and the four third pivoting mechanisms 300 are disposed in a region enclosed by the flattened screen frame (i.e., a rectangular frame). The four third pivoting mechanisms 300 are located in the area enclosed by the screen frame after it is flattened (i.e., rectangular frame). In this way, after the bearing surface of the screen frame bears the flexible screen, the appearance effect of the projection screen will not be affected.

It should be noted that in addition to the structure described above, the third pivoting mechanism 300 may also adopt other structures, which are not specifically limited in the embodiments of the present disclosure.

In one possible implementation, referring to FIG. 13 and FIG. 29, FIG. 29 is a schematic structural diagram of a first pivoting mechanism according to some embodiments of the present disclosure. The first pivoting mechanism 102 in each first foldable frame segment 100 includes two leaves 1021 fixedly connected to the first ends of the two first frame sub-segments 101 respectively, and a rotation shaft 1022 disposed between the two leaves 1021 and rotatably connected to the two leaves 1021, respectively. The two leaves 1021 are rotatably connected relative to each other by the rotation shaft 1022, with an center axis F4 of the rotation shaft 1022 being parallel to the first axis L1. In this way, the two first frame sub-segments 101 can be rotated relative to each other under the action of the two leaves 1021 and the rotation shaft 1022.

In one possible implementation, the first pivoting mechanism 102 may also adopt the structure shown in FIGS. 38 and 39.

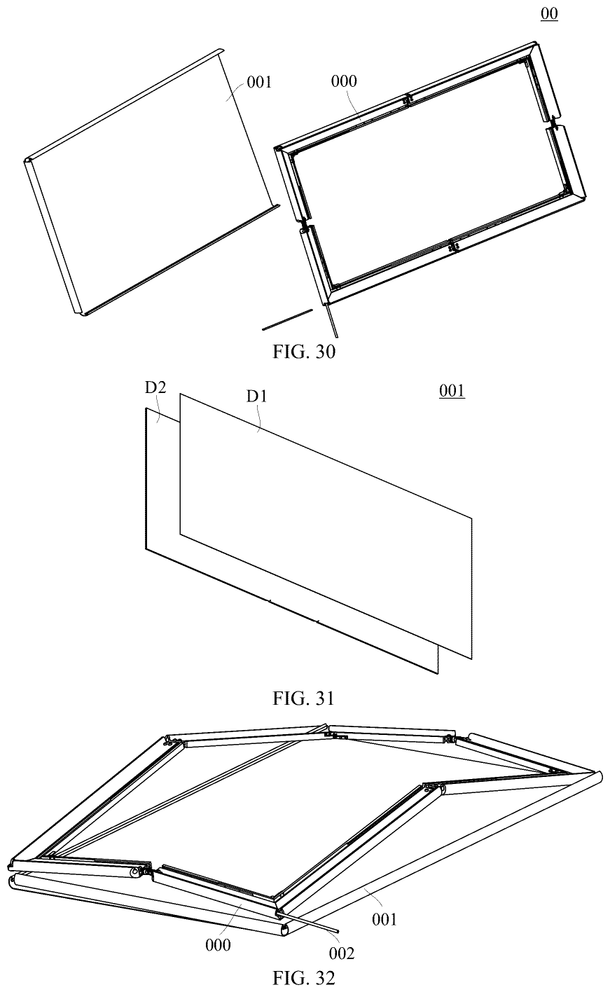

The embodiments of the present disclosure also provide a projection screen, referring to FIG. 30, FIG. 30 is an exploded schematic diagram of a projection screen according to some embodiments of the present disclosure. The projection screen 00 includes a flexible screen 001 and a screen frame 000. The flexible screen 001 conforms to a bearing surface of the screen frame 000. The screen frame 000 is any one of the screen frames given above.

In this way, the screen frame 000 of the projection screen 00 can be reduced in volume by folding for convenient transportation. After entering the user's residence, the screen frame 000 can be folded to a state suitable for assembling the flexible screen 001 by the cooperation of the three pivoting mechanisms in the screen frame 000. Then, after the flexible screen 001 is assembled to the screen frame 000, the flexible screen 001 is flattened by unfolding the screen frame 000 combined with its elastic deformation. Thereby, while ensuring the flatness of the flexible screen 001, the material cost of the projection screen 00 is reduced, the assembly process of the user is simplified, the assembly time is saved, and the user's experience is improved.

In one possible implementation, referring to FIG. 31, FIG. 31 is an exploded schematic diagram of a flexible screen according to some embodiments of the present disclosure. The flexible screen 001 includes a screen sheet D1 and a flexible carrier D2. The screen sheet D1 is fixed to one side of the flexible carrier D2, and the edges of the flexible carrier D2 extend beyond the four side edges of the screen sheet D1. The other side of the flexible carrier D2 conforms to the front side of the rectangular frame A, and the edges of the flexible carrier D2 are folded to wrap around the edges of the rectangular frame A. The screen sheet D1 may be an optical film, which is used in conjunction with a projection host. The projection host is used to emit a light beam to the optical film, and the optical film is used to receive and reflect the light beam to display an image. The screen sheet D1 may be fixed to the flexible carrier D2 using adhesion.

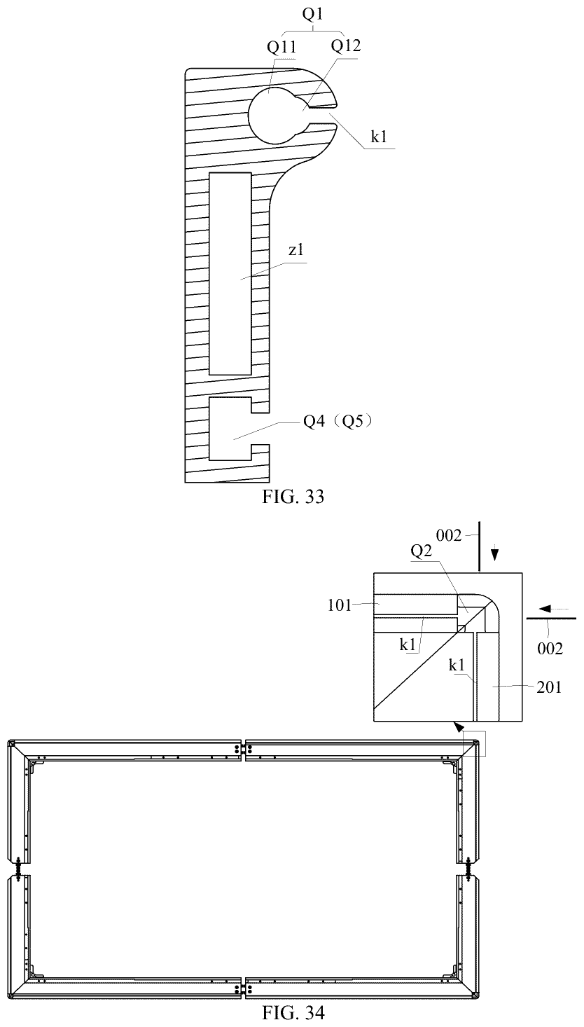

In one possible implementation, referring to FIG. 32 and FIG. 33, FIG. 32 is an exploded schematic diagram of another projection screen according to some embodiments of the present disclosure, and FIG. 33 is a cross-sectional view of one frame sub-segment of a screen frame shown in FIG. 32. The projection screen 00 also includes a plurality of support rods 002. A side of the screen frame 000 away from the bearing surface is provided with a bearing cavity Q1 and an opening k1 in communication with the bearing cavity Q1. An edge portion of the flexible screen 001 in the projection screen 00 is connected to the plurality of support rods 002 after wrapping around an edge of the screen frame 000, and each of the support rods 002 can be clamped into the bearing cavity Q1 through the opening k1 in communication with the bearing cavity Q1. In this case, the support rods 002 can be clamped into the bearing cavities Q1 after being connected to the edge portions of the flexible screen 001. When the screen frame 000 is flattened to stretch the flexible screen 001, the bearing cavities Q1 on the screen frame 000 can limit the support rods 002 to assist in tensioning the flexible screen 001.

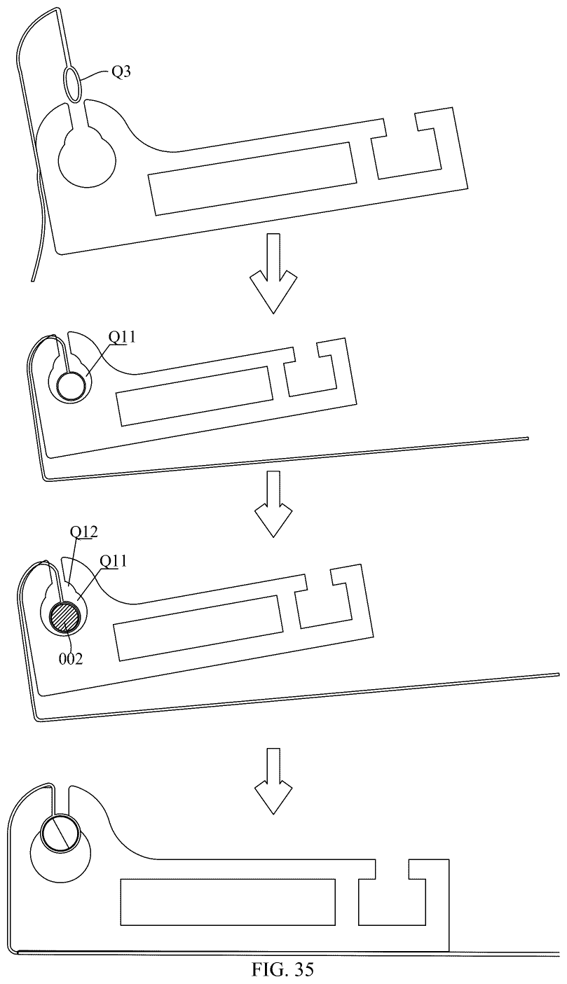

In one possible implementation, reference is made to FIG. 34, FIG. 34 is an installation schematic diagram of a support rod according to some embodiments of the present disclosure. A corner portion of the side of the screen frame 000 away from the bearing surface may be provided with a notch groove Q2 that communicates with the bearing cavity Q1. The notch groove Q2 can be used to allow the support rod 002 to penetrate into the bearing cavity Q1 along the direction indicated by the arrow in the figure, so as to connect with an edge portion of the flexible screen 001 disposed in the bearing cavity Q1.

In one possible implementation, as shown in FIG. 33, the bearing cavity Q1 in the screen frame 000 may include a first sub-bearing cavity Q11 and a second sub-bearing cavity Q12 that are in communication with each other. The first sub-bearing cavity Q11 is closer to the bearing surface of the screen frame 000 than the second sub-bearing cavity Q12, and the width of the first sub-bearing cavity Q11 is greater than the width of the second sub-bearing cavity Q12. This facilitates the installation of the support rod 002 into the bearing cavity Q1.

Exemplarily, referring to FIG. 35, FIG. 35 is an installation schematic diagram of a flexible screen with a screen frame according to some embodiments of the present disclosure. The assembly and tensioning process of the screen frame 000 and the flexible screen 001 is schematically illustrated herein.

First, after the screen frame 000 is in the user's residence, the screen frame 000 is folded to a suitable state that facilitates the installation of the flexible screen 001.

The embodiments of the present disclosure adopt the folding and unfolding of the screen frame 000 to achieve the installation and tensioning of the flexible screen 001. To this end, the size of the flexible carrier D2 (i.e., synthetic fabric) in the flexible screen 001 is usually smaller than the size of the screen frame 000 when unfolded, i.e., the width of the synthetic fabric is smaller than the distance between the outer sides of the two first foldable frame segments 100 in the rectangular frame, and the length of the synthetic fabric is smaller than the distance between the outer sides of the two second foldable frame segments 200 in the rectangular frame. In this way, after the rectangular frame is flattened, the screen sheet D1 can be tensioned through the elastic deformation capability of the synthetic fabric itself.

Afterwards, the accommodation pocket Q3 of the edge portion of the flexible screen 001 (i.e., the accommodation pocket provided at the edge portion of the synthetic fabric) is placed into the first sub-bearing cavity Q11.

Afterwards, the support rod 002 is extended into the first sub-bearing cavity Q11 through the notch groove Q2 and penetrated into the accommodation pocket Q3.

Afterwards, the screen frame 000 can be adjusted to gradually flatten. During the flattening process, the support rod 002 gradually moves from the first sub-bearing cavity Q11 to the second sub-bearing cavity Q12, and is interfaced with the second sub-bearing cavity Q12. It should be noted that the screen frame 000 may still have a certain flattening space.

Afterwards, the screen frame 000 continues to flatten, causing the synthetic fabric in the flexible screen 001 to undergo a certain elastic deformation, which drives the screen sheet D1 to be tensioned and completes the assembly of the projection screen 00. As can be seen from the above, in the embodiments of the present disclosure, when the screen frame is unfolded to a certain extent (where the screen frame is not fully unfolded), the flexible screen is assembled with the screen frame. In this way, there is no need to use other components to assist in tensioning the flexible screen. The remaining unfolding amount of the screen frame can be used to tension the flexible screen, and the screen frame can also be flattened at this time.

In the embodiments of the present disclosure, a plurality of frame sub-segments in the screen frame 000 may be provided with a bearing cavity Q1, and a plurality of support rods 002 may be in one-to-one correspondence with the plurality of frame sub-segments. Each support rod 002 is clamped into the bearing cavity Q1 in the corresponding frame sub-segment after being connected to an edge portion of the flexible screen 001 (e.g., the edge portion of the flexible screen may be provided with an accommodation pocket, and the support rod may be disposed within the accommodation pocket). Exemplarily, each of the two first frame sub-segments 101 in each first foldable frame segment 100 may be provided with a bearing cavity Q1, and the plurality of support rods 002 in the projection screen 00 includes two support rods 002 in one-to-one correspondence with the bearing cavities Q1 of the two first frame sub-segments 101. Each of the two second frame sub-segments 201 in each second foldable frame segment 200 may be provided with a bearing cavity Q1, and the plurality of support rods 002 in the projection screen 00 also includes two support rods 002 in one-to-one correspondence with the bearing cavities Q1 of the two second frame sub-segments 201.

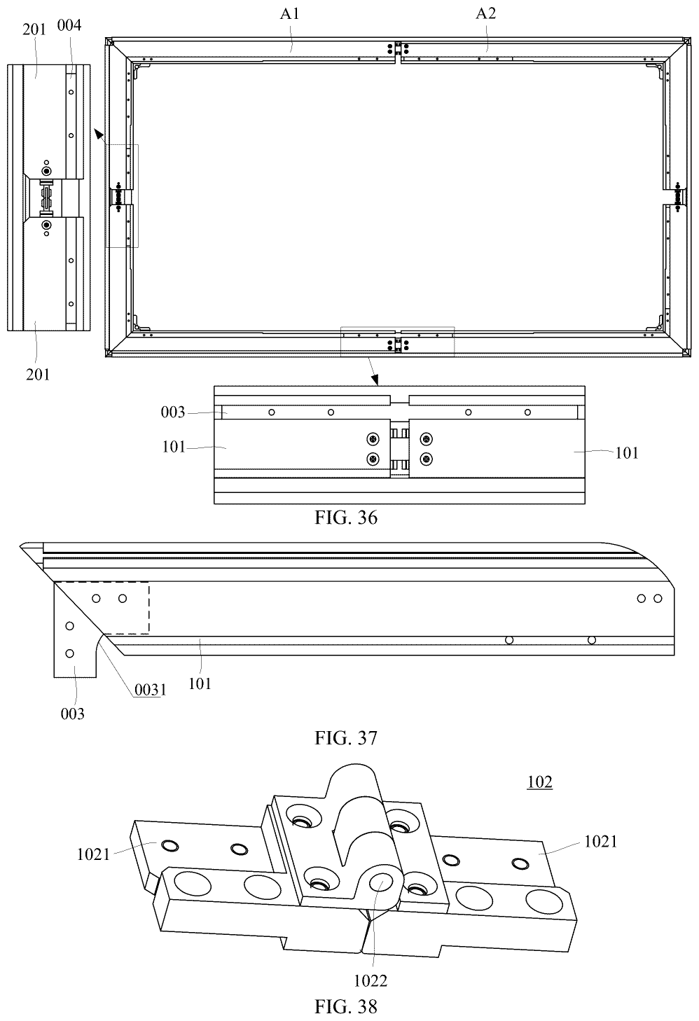

In one possible implementation, referring to FIG. 36, FIG. 36 is a schematic structural diagram of a projection screen according to some embodiments of the present disclosure. The first limiting member 103 may be detachably connected to at least one of the two first frame sub-segments 101, and the first limiting member 103 may be used to limit the two first frame sub-segments 101 to a coplanar position. In this way, after the first frame A1 and the second frame A2 are rotated to the coplanar position, the first frame A1 and the second frame A2 can be fixedly connected to the two first frame sub-segments 101 by the first limiting member 103 respectively, so as to avoid relative rotation of the first frame A1 and the second frame A2. When the rectangular frame needs to be folded, the first limiting member 103 can be removed from one of the first frame sub-segments 101.

The second limiting member 203 may be detachably connected to at least one of the two second frame sub-segment 201, and the second limiting member 203 may be used to limit the two second frame sub-segment 201 to the coplanar position. In this way, when the two second frame sub-segments 201 in each second folding side frame 200 are rotated to the coplanar position, the two second frame sub-segments 201 can be fixedly connected to the two second frame sub-segments 201 by the second limiting member 203 respectively, so as to avoid relative rotation of the two second frame sub-segments 201. When the rectangular frame needs to be folded, the second limiting member 203 can be removed from one of the second frame sub-segments 201.

The embodiments of the present disclosure do not limit the installation manner of the first limiting member 103 and the second limiting member 203. In one possible implementation, as shown in FIGS. 33 and 36, the side of the screen frame 000 away from the bearing surface is provided with a first sliding groove Q4 corresponding to the first limiting member 103 and a second sliding groove Q5 corresponding to the second limiting member 203. The first limiting member 103 is disposed within the first sliding groove Q4 and can be slidably connected to the first sliding groove Q4. The second limiting member 203 is disposed in the second sliding groove Q5 and can be slidably connected to the second sliding groove Q5. In this way, the sliding grooves can accommodate and position the limiting members, such that the projection screen 000 has a better appearance. When the screen frame 000 is in the unfolded state, a portion of the first limiting member 103 extends into one first frame sub-segment 101 (the first sliding groove Q4), and the other portion extends into the other first frame sub-segment 101 (the first sliding groove Q4). A portion of the second limiting member 203 extends into one second frame sub-segment 201 (the second sliding groove Q5) and another portion extends into the other second frame sub-segment 201 (the second sliding groove Q5).

In another possible implementation, as shown in FIG. 25, the first limiting member 103 is rotatably connected to the first end of one first frame sub-segment 101 and detachably connected to the first end of the other first frame sub-segment 101. The second limiting member 203 is rotatably connected to the first end of one second frame sub-segment 201 and detachably connected to the first end of the other second frame sub-segment 201.

In the embodiments of the present disclosure, in order to ensure the stability of the screen frame 000 supporting the flexible screen 001 after the flexible screen 001 conforms to the screen frame 000. Referring to FIG. 37, FIG. 37 is a schematic structural diagram of a portion of a projection screen according to some embodiments of the present disclosure. The projection screen 00 further includes an angle iron 003 connected to a second end of the first frame sub-segment 101 and a second end of the second frame sub-segment 201 After the screen frame 000 is flattened, the angle iron 003 is fixedly connected to the second end of the first frame sub-segment 101 and the second end of the second frame sub-segment 201 respectively, such that when the second frame sub-segment 201 in the screen frame 000 is folded, the angle iron 003 can be separated from the second end of the second frame sub-segment 201.

It should be noted that to ensure that when the second frame sub-segment 201 is rotated relative to the first frame sub-segment 101, there is no interference between the corners of the second frame sub-segment 201 and the corners of the first frame sub-segment 101, the angle iron 003. The angle iron 003 may have an avoidance region 0031 that is used to avoid the rotation regions of the first frame sub-segment 101 and the second frame sub-segment 201 when the first frame sub-segment 101 and the second frame sub-segment 201 are rotated relative to each other.

It should be added that in addition to adopting the first pivoting mechanism 102 described above, the embodiments of the present disclosure also provide another implementation of the first pivoting mechanism 102. As shown in FIGS. 38 and 39, the first pivoting mechanism 102 includes two leaves 1021 and a rotation shaft 1022. The two leaves 1021 are rotatably connected relative to each other by the rotation shaft 1022. The center axis F4 of the rotation shaft 1022 is parallel to the first axis L1. In this way, the two first frame sub-segments 101 can be rotated relative to each other under the action of the two leaves 1021 and the rotation shaft 1022.

The center axises of the two leaves 1021 of the first pivoting mechanism 102 shown in FIGS. 11, 12, and 29 are parallel, while the center axises of the two leaves 1021 of the first pivoting mechanism 102 shown in FIGS. 38 and 39 are collinear, i.e., FIGS. 38 and 39 show a single-axis hinge.

In addition to second pivoting mechanism 202 described above, the embodiments of the present disclosure provide another implementation of the second pivoting mechanism 202. As shown in FIGS. 40 to 42, the second pivoting mechanism 202 includes two adapters 2021 and a connecting member 2022. An end portion of each adapter 2021 away from the second frame sub-segment 201 is rotatably connected to the connecting member 2022 by the first pivoting shaft 2023. An center axis F1 of the first pivoting shaft 2023 is parallel to the second axis L2.

In one possible implementation, as shown in FIG. 40 to FIG. 42, the second pivoting mechanism 202 also includes two ejectors 2024, and the two ejectors 2024 are movably connected to the connecting member 2022. An end portion of each adapter 2021 away from the second frame sub-segment 201 is provided with a locking groove 20212. When the two second frame sub-segments 201 are in the unfolded state, the ejectors 2024 extend into the locking grooves 20212 to limit the two adapters 201 in the unfolded state, making the screen frame 000 more stable in the unfolded state.

The embodiments of the present disclosure do not limit the implementation in which the ejector 2024 extends into the locking groove 20212. In one possible implementation, the ejector 2024 is threadedly connected to the connecting member 2022, and the moving direction of the ejector 2024 is perpendicular to the adapter 2021. Thus, the user can rotate the ejector 2024 to make the ejector 2024 extend into the locking groove 20212.

In another possible implementation, as shown in FIG. 42, the connecting member 2022 is provided with two sliding grooves 20221, and two ejectors 2024 are respectively disposed in the two sliding grooves 20221. The second pivoting mechanism 202 also includes two elastic members 2025, and the two elastic members 2025 are respectively used to drive the two ejectors 2024 to extend outward from the sliding grooves 20221. When the two second frame sub-segments 201 are in the unfolded state, the elastic members 2025 drive the ejectors 2024 to extend into the locking grooves 20212. The two elastic members 2025 can be respectively disposed in the two sliding grooves 20221 and abut against the bottoms of the ejectors 2024.

In the technical solution according to the embodiments of the present disclosure, when the second pivoting mechanism 202 is rotated to the unfolded state, the locking groove 20212 is opposite to the ejector 2024, and then, under the action of the elastic member 2025, the ejector 2024 automatically extends into the locking groove 20212, thereby limiting the second pivoting mechanism 202 to the unfolded state. It can be seen that the second pivoting mechanism 202 provided in the embodiments of the present disclosure can be automatically locked when it is rotated to the unfolded state.

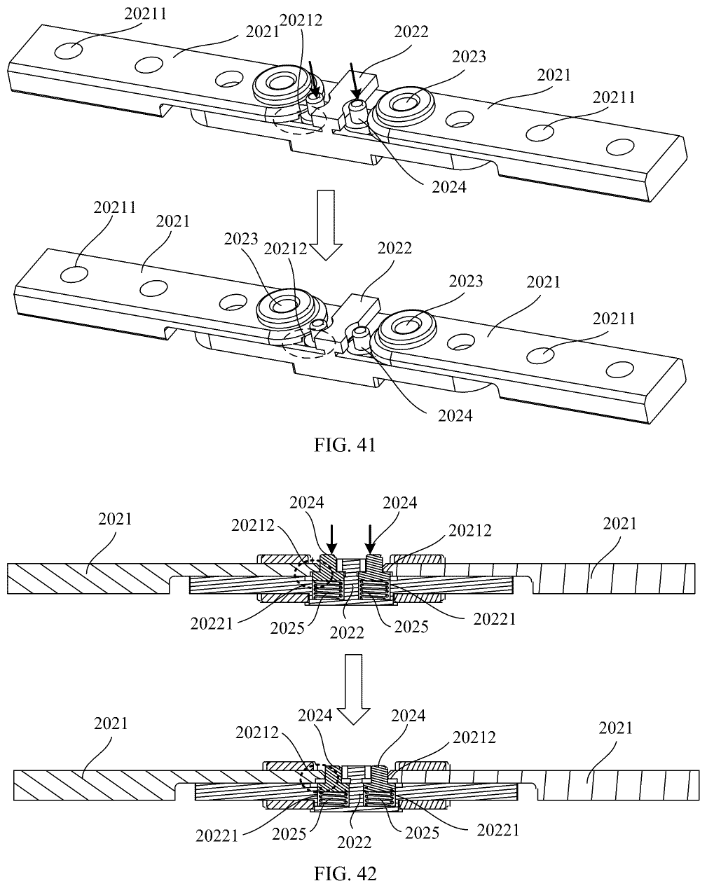

When the screen frame 000 needs to be folded, as shown by the black arrows in FIGS. 41 and 42, the user presses the two ejectors 2024 to make the ejectors 2024 disengage from the locking grooves 20212 to release the locking state of the second pivoting mechanism 202. After that, the user can fold the screen frame 000 normally.

In one possible implementation, the two adapters 2021 are used to be fixedly connected to the two second frame sub-segments 201 respectively. For example, as shown in FIGS. 40 and 41, the adapter 2021 is provided with a plurality of mounting holes 20211, and the plurality of mounting holes 20211 are used to be fixed connected to the second frame sub-segment 201.

In another possible implementation, the two adapters 2021 can also be respectively used for rotational connection with the two second frame sub-segments 201, and the center axis of rotation is perpendicular to the first pivoting shaft. The two adapters 2021 can achieve a state in which the first pivoting shaft is parallel to the second axis L2 and a state in which the first pivoting shaft is parallel to the third axis L3 through rotation. For the implementation of the rotational connection between the adapter 2021 and the second frame sub-segment 201, reference may be made to FIG. 6 to FIGS. 7 and FIG. 21 to FIG. 22, and in the corresponding text content, which will not be repeated herein.

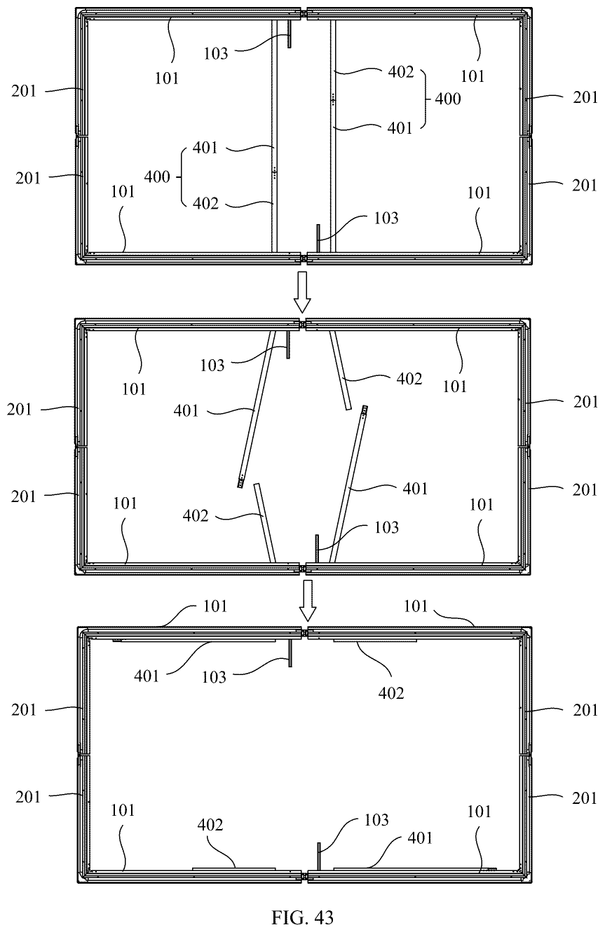

In one possible implementation, as shown in FIG. 43, the screen frame 000 also includes two vertical beams 400. Each vertical beam 400 includes an integral structural member. When the screen frame 000 is in the unfolded state, two ends of each vertical beam 400 are respectively connected to two oppositely-arranged first frame sub-segments 101. In this way, the stability of the screen frame 000 in the unfolded state can be improved. The two vertical beams 400 are connected to two pairs of oppositely-arranged first frame sub-segments 101, respectively.

The embodiments of the present disclosure do not limit the connection between the vertical beam 400 and the first frame sub-segment 101. In one possible implementation, the two ends of the vertical beam 400 are detachably connected to the first frame sub-segment 101, such that when the screen frame 000 is in the folded state, the vertical beam 400 can be separated from the first frame sub-segment 101 to prevent the vertical beam 400 from obstructing the folding of the screen frame 000. After the screen frame 000 is unfolded, the vertical beam 400 is then connected to the first frame sub-segment 101.

In another possible implementation, as shown in FIG. 43, the vertical beam 400 includes a first sub-beam 401 and a second sub-beam 402, with the first end of the first sub-beam 401 rotatably connected to one first frame sub-segment 101. The first end of the second sub-beam 402 is rotatably connected to the other first frame sub-segment 101. Moreover, when the screen frame 000 is in the unfolded state, the second end of the first sub-beam 401 is connected to the second end of the second sub-beam 402, then the first sub-beam 401 and the second sub-beam 402 form the vertical beam 400 and support the two first frame sub-segments 101.

As shown in FIG. 43, when the screen frame 000 is in the folded state (or understood as before the screen frame 000 is folding), the second end of the first sub-beam 401 is separated from the second end of the second sub-beam 402, and the first sub-beam 401 and the second sub-beam 402 are rotated to be stowed relative to the first foldable frame segment 100. In this way, the presence of the vertical beam 400 does not affect the folding of the first foldable frame segment 100 and the second foldable frame segment 200. Moreover, the vertical beam 400 is integrated with the first foldable frame segment 100, which improves the integration of the screen frame 000.

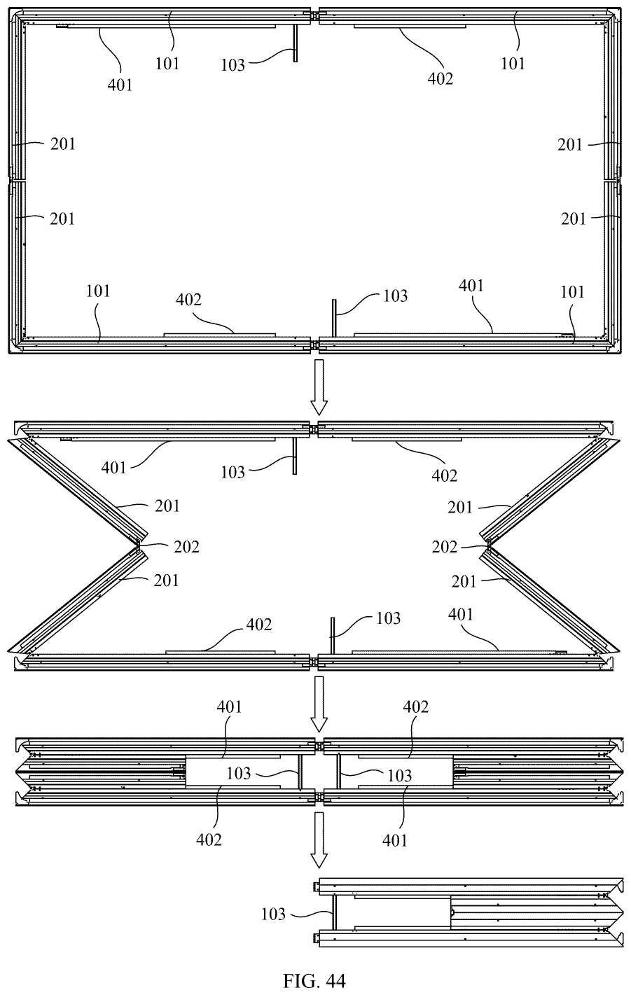

As shown in FIG. 44, the screen frame 000 can be folded normally when the first sub-beam 401 and the second sub-beam 402 are stowed.

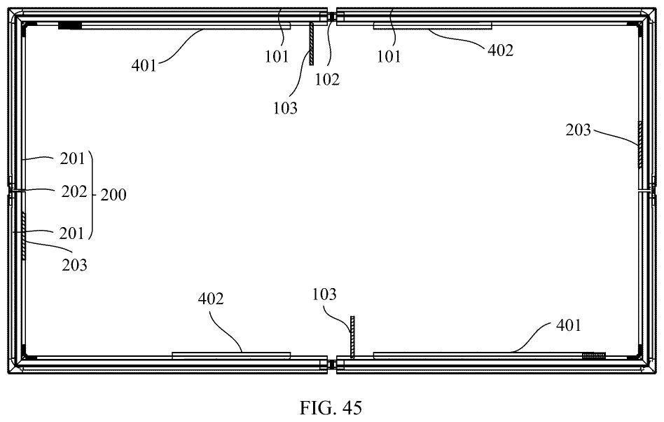

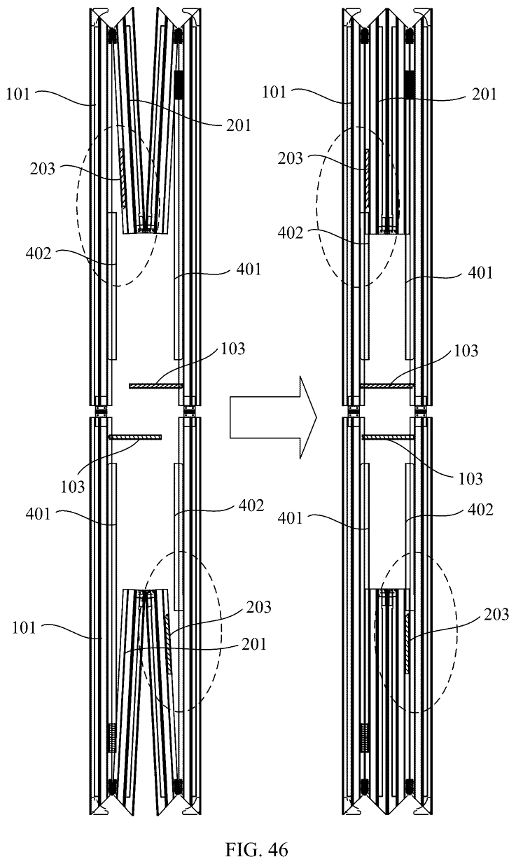

In one possible implementation, as shown in FIGS. 45 and 46, each second foldable frame segment 200 also includes a second limiting member 203. Moreover, when the screen frame 000 is in the unfolded state, the first end of the second limiting member 203 is rotatably connected to one second frame sub-segment 201, and the second end is detachably connected to the other second frame sub-segment 201, to limit the two second frame sub-segments 201 to a coplanar position. When the screen frame 000 is in the folded state, the second limiting member 203 is stowed relative to the second frame sub-segment 201 to which the first end of the second limiting member 203 is connected.

As shown in FIG. 45, when the screen frame 000 is in the folded state, the second frame sub-segment 201 will conform to the adjacent first frame sub-segment 101, and the sub-beams (the first sub-beam 401 and the second sub-beam 402) will be stowed relative to the first frame sub-segment 101 due to the second limiting member 203 being stowed relative to the second frame sub-segment 201. Moreover, as shown in FIG. 45, a portion of the sub-beams will protrude relative to the first frame sub-segments 101 in the stowed state. Therefore, if the sub-beam comes into contact with the second limiting member 203 in the folded state, the first frame sub-segment 101 and the second frame sub-segment 201 will fail to fit tightly together, affecting the folding effect.

In one possible implementation, as shown in FIGS. 45 and 46, to avoid interference between the second limiting member 203 and the sub-beam, the length of the first sub-beam 401 is greater than the length of the second sub-beam 402. The first frame sub-segment 101 connected to the first end of the second sub-beam 402 is adjacent to the second frame sub-segment 201 connected to the first end of the second limiting member 203, and the second sub-beam 402 is not in contact with the second limiting member 203 when the screen frame 000 is in the folded state. Then the portion of the second sub-beam 402 protruding relative to the first frame sub-segment 101 can extend into the second frame sub-segment 201 without being blocked by the second limiting member 203.

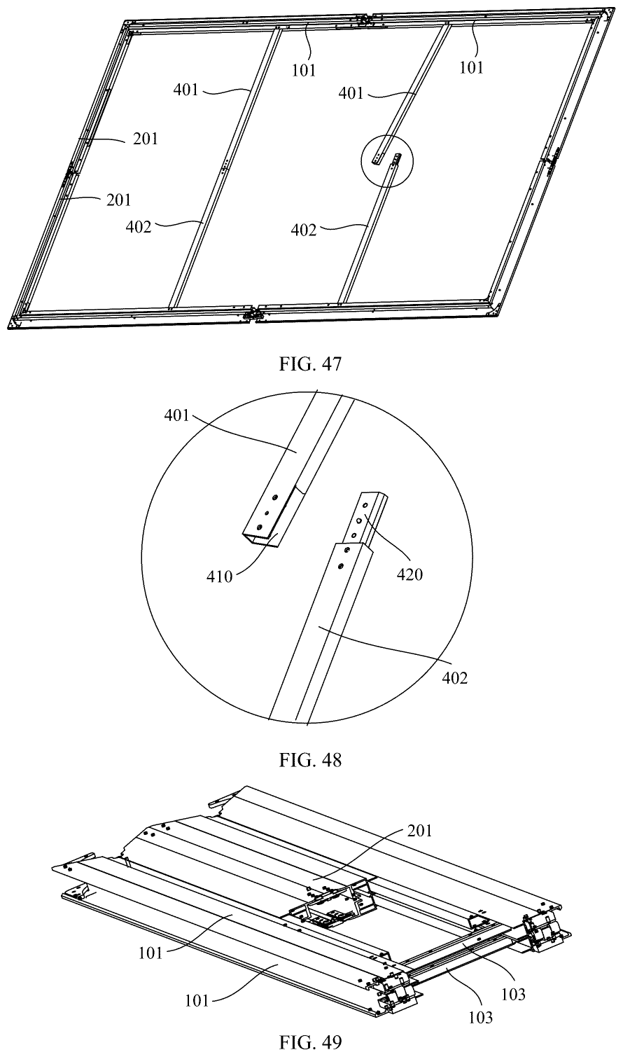

In another possible implementation, if the problem of interference described above does not exist, the lengths of the first sub-beam 401 and the second sub-beam 402 may also be the same, as shown in FIG. 47.

The embodiments of the present disclosure do not limit the connection between the second end of the first sub-beam 401 and the second end of the second sub-beam 402. In one possible implementation, as shown in FIGS. 47 and 48, one of the second end of the first sub-beam 401 and the second end of the second sub-beam 402 is provided with an accommodating groove 410, and the other is provided with a fixing block 420. When the screen frame 000 is in the unfolded state, the fixing block 420 extends into the accommodating groove 410 to realize the connection between the second end of the first sub-beam 401 and the second end of the second sub-beam 402.

In one possible implementation, the first sub-beam 401 and the second sub-beam 402 are connected by a pin shaft, which passes through the second ends of the first sub-beam 401 and the second sub-beam 402, or understood as passing through the end portion where the fixing block 420 and the accommodating groove 410 are located.

In one possible implementation, as shown in FIG. 48, the opening of the accommodating groove 410 is disposed at the end portion and the first side of the sub-beam, which is the first sub-beam 401 or the second sub-beam 402, and the first side is a side on which the sub-beam conforms to the first foldable frame segment 100 when the screen frame is in the folded state. In this way, not only the entry and exit of the fixing block 420 into and out of the accommodating groove 410 is realized, but also the rotation directions of the first sub-beam 401 and the second sub-beam 402 are restricted, preventing the first sub-beam 401 and the second sub-beam 402 from rotating in the reverse direction (as shown in the middle portion of FIG. 43).

In one possible implementation, as shown in FIG. 49, FIG. 46, and FIG. 44, the above-described first limiting member 103 may also perform the following functions. When the screen frame 000 is in the folded state, one end of the first limiting member 103 is rotatably connected to one first frame sub-segment 101 of one first foldable frame segment 100, and the other end of the first limiting member 103 is rotatably connected to one first frame sub-segment 101 of the other first foldable frame segment 100. Moreover, the two first frame sub-segments 101 connected to the two ends of the first limiting member 103 are opposite to each other. In this way, the stability of the screen frame 000 in the folded state can be improved.

It should be noted that, for the case where the second pivoting mechanism 202 can drive the two second frame sub-segments 201 to rotate around the second axis L2, and can also drive the two second frame sub-segments 201 to rotate around the third axis L3, as shown in FIG. 32, when mounting the flexible screen 001 on the screen frame 000, driving the two second frame sub-segments 201 to rotate by the second pivoting mechanism 202 can realize an umbrella-like structure to facilitate mounting of the flexible screen 001. Moreover, the flexible screen 001 can be tensioned by continuing to flatten the screen frame 000.

However, in the case where the second pivoting mechanism 202 can not only drive the two second frame sub-segments 201 to rotate around the second axis L2 (i.e., the implementation in which the adapter 2021 is fixedly connected to the second frame sub-segments 201 as shown in FIG. 40 to FIG. 42), the above-mentioned umbrella-like structure cannot be realized, and the flexible screen 001 cannot be tensioned by flattening the screen frame 000. For the screen frame 000 with such a second pivoting mechanism 202, the following method can be adopted to realize the installation and tensioning of the flexible screen 001.

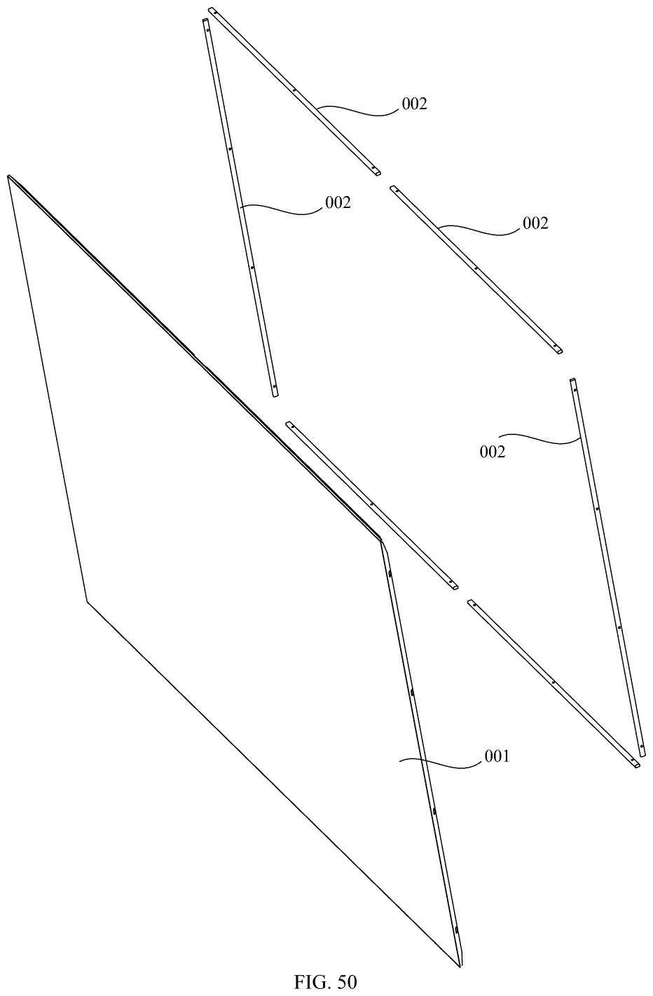

First, as shown in FIG. 50, a support rod 002 is threaded within the flexible screen 001, and, the holes in the flexible screen 001 correspond to the holes in the support rod 002.

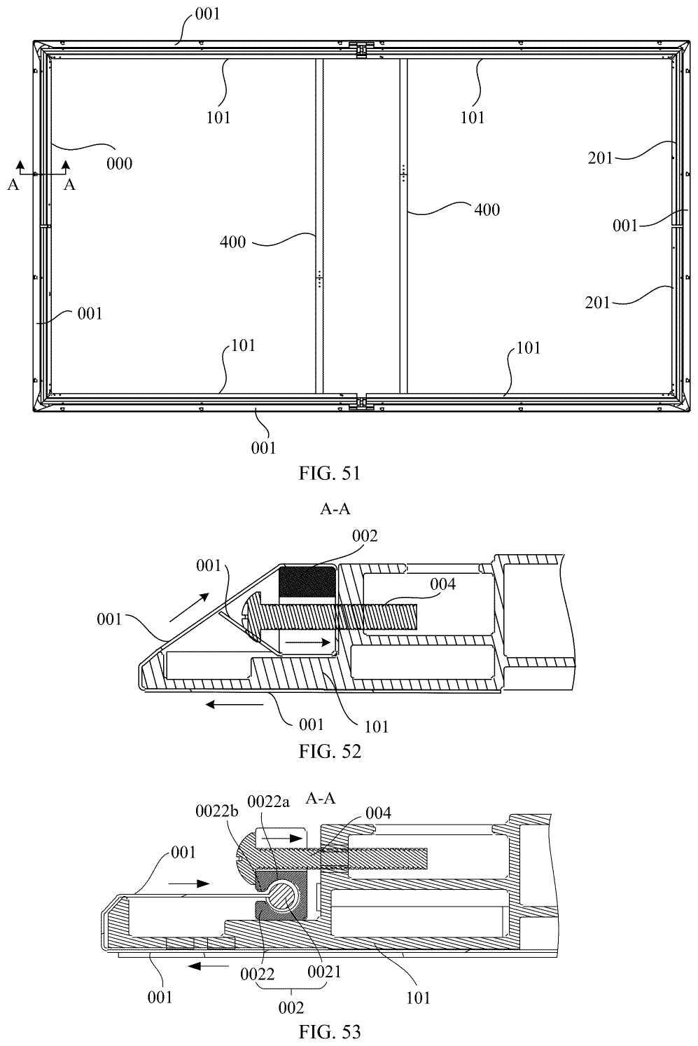

Then, as shown in FIG. 51 to FIG. 52, the holes in the flexible screen 001, the holes in the support rods 002, and the threaded holes in the screen frame 000 are centered, and the locking screw 004 is used to pass through the flexible screen 001, the support rods 002, and screwed in the screen frame 000. As shown in FIG. 52, in the process of screwing the locking screw 004, the screw 004 drives the support rod 002 toward the center of the screen frame 000 and gradually tensions the flexible screen 001.

In one possible implementation, as shown in FIG. 52, an edge portion of the flexible screen 001 is connected to the support rod 002 (e.g., an edge portion of the flexible screen 001 wraps around the support rod 002), and an edge portion of the flexible screen 001 wraps around the edge of the screen frame. The locking screw 004 passes through the support rod 002 and is screwed into the screen frame 001.

As shown in the direction of the arrow in FIG. 52, in the process of tightening the locking screw 004, the locking screw 004 drives the support rod 002 toward the inner side of the screen frame 000, and the support rod 002 drives the flexible screen 001 to be tensioned.

In another possible implementation, as shown in FIG. 53, the support rod 002 is composed of a rod body 0021 and a locking strip 0022. The locking strip 0022 is provided with a bearing cavity 0022a and an opening 0022b connected to the bearing cavity 0022a. The bearing cavity 0022a extends along the edge of the screen frame. The edge portion of the flexible screen 001 wraps around the edge of the screen frame 000 and is connected to the rod body 0021, and the rod body 0021 is clamped into the bearing cavity 0022a through the opening 0022b. The locking screw 004 passes through the locking strip 0022 and is screwed into the screen frame 000.

As shown in the direction of the arrow in FIG. 53, in the process of tightening the locking screw 004, the locking screw 004 drives the locking strip 0022 toward the inner side of the screen frame 000, the locking strip 0022 drives the rod body 0021 toward the inner side of the screen frame 000, and the rod body 0021 drives the flexible screen 001 to be tensioned.

The above are only optional embodiments of the present disclosure and are not intended to limit the present disclosure. Any modifications, equivalent substitutions, improvements, etc. made within the principles of the present disclosure shall be included in the protection scope of this application.

1. A screen frame, having a bearing surface, the screen frame comprising two oppositely-arranged first foldable frame segments, two oppositely-arranged second foldable frame segments, and a third pivoting mechanism; wherein
each of the first foldable frame segments comprises two first frame sub-segments and a first pivoting mechanism, wherein first ends of the two first frame sub-segments are connected by the first pivoting mechanism, the first pivoting mechanism is configured to drive the two first frame sub-segments to fold or unfold around a first axis parallel to the bearing surface;
each of the second foldable frame segments comprises two second frame sub-segments, and at least one second foldable frame segment further comprises a second pivoting mechanism, wherein the second pivoting mechanism is connected between first ends of two second frame sub-segments of one second foldable border frame, and the second pivoting mechanism is configured to drive two corresponding second frame sub-segments to fold or unfold around a second axis intersecting the bearing surface; and
the third pivoting mechanism is connected between a second end of a first frame sub-segment and a second end of a second frame sub-segment, and the third pivoting mechanism is configured to drive the second frame sub-segment to rotate relative to the first frame sub-segment around a fourth axis perpendicular to the bearing surface.

2. The screen frame according to claim 1, wherein each of the second foldable frame segments comprises the second pivoting mechanism.

3. The screen frame according to claim 1, wherein one of the second foldable frame segments comprises the second pivoting mechanism, and first ends of two second frame sub-segments in another of the second foldable frame segments are separated.

4. The screen frame according to claim 1, wherein the second pivoting mechanism comprises two adapters connected to the first ends of the two second frame sub-segments respectively and a connecting member disposed between the two adapters; wherein
an end portion of each of the adapters away from the second frame sub-segment is rotatably connected to the connecting member by a first pivoting shaft, wherein the first pivoting shaft is at least capable of being parallel to the second axis.

5. The screen frame according to claim 4, wherein a limiting recess is arranged on an end portion of the connecting member close to the adapter, and the adapter is connected to the connecting member within the limiting recess by the first pivoting shaft.

6. The screen frame according to claim 4, wherein the second pivoting mechanism further comprises two ejectors, the two ejectors being movably connected to the connecting member; wherein
a locking groove is arranged on an end portion of each of the adapters away from the second frame sub-segment; and
in response to the two second frame sub-segments being in an unfolded state, the ejectors extend into the locking grooves respectively to limit the two adapters in the unfolded state.

7. The screen frame according to claim 6, wherein two sliding grooves are arranged on the connecting member, the two ejectors being disposed in the two sliding grooves respectively;
the second pivoting mechanism further comprises two elastic members, wherein the two elastic members are configured to drive the ejectors to extend towards an outside of the sliding grooves, respectively; and
in response to the two second frame sub-segments being in the unfolded state, the elastic members drive the ejectors to extend into the locking grooves.

8. The screen frame according to claim 4, wherein the two adapters are fixedly connected to the first ends of the two second frame sub-segments respectively, and the first pivoting shaft is parallel to the second axis.

9. The screen frame according to claim 4, wherein the two adapters are rotatably connected to the first ends of the two second frame sub-segments respectively, and a center axis of rotation of each of the two adapters is perpendicular to the first pivoting shaft;
the two adapters are capable of being rotated to achieve a state in which the first pivoting shaft is parallel to the second axis, and a state in which the first pivoting shaft is parallel to a third axis, wherein the third axis is parallel to the bearing surface and perpendicular to the first axis; and
the second pivoting mechanism is further configured to drive the two corresponding second frame sub-segments to rotate about the third axis.

10. The screen frame according to claim 1, wherein the two second frame sub-segments are disposed between the two first foldable frame segments after the two second frame sub-segments are folded by the second pivoting mechanism.

11. The screen frame according to claim 1, wherein the first pivoting mechanism comprises two leaves fixedly connected to the first ends of the two first frame sub-segments, and a pivot pin disposed between the two leaves; wherein
the two leaves are rotatably connected relative to each other by the pivot pin, a center axis of the pivot pin being parallel to the first axis.

12. The screen frame according to claim 1, wherein the third pivoting mechanism comprises a first fixing member and a second fixing member, and a third pivoting shaft rotatably connected to the first fixing member and the second fixing member, respectively; and
the first fixing member is fixedly connected to a second end of one of the first frame sub-segments, and the second fixing member is fixedly connected to a second end of one of the second frame sub-segments, wherein a center axis of the third pivoting shaft is parallel to the fourth axis.

13. The screen frame according to claim 1, wherein each of the first foldable frame segments further comprises a first limiting member, the first limiting member being connected to the two first frame sub-segments respectively to limit the two first frame sub-segments to a coplanar position; and/or,
each of the second foldable frame segments further comprises a second limiting member, the second limiting member being connected to the two second frame sub-segments respectively to limit the two second frame sub-segments to a coplanar position.

14. The screen frame according to claim 1, further comprising two vertical beams, wherein in response to the screen frame being in an unfolded state, two ends of each of the vertical beams are connected to two oppositely-arranged first frame sub-segments.

15. The screen frame according to claim 14, wherein each of the vertical beams comprises a first sub-beam and a second sub-beam, wherein a first end of the first sub-beam is rotatably connected to one of the first frame sub-segments, and a first end of the second sub-beam is rotatably connected to another of the first frame sub-segments; and
in response to the screen frame being in the unfolded state, a second end of the first sub-beam is connected to a second end of the second sub-beam; and in response to the screen frame being in a folded state, the second end of the first sub-beam is separated from the second end of the second sub-beam, and the first sub-beam and the second sub-beam are rotated to be stowed relative to the first foldable frame segment.

16. The screen frame according to claim 15, wherein each of the second foldable frame segments further comprises a second limiting member, wherein in response to the screen frame being in the unfolded state, a first end of the second limiting member is rotatably connected to one of the two second frame sub-segments, and another end of the second limiting member is detachably connected to another second frame sub-segment to limit the two second frame sub-segments to a coplanar position; and in response to the screen frame being in the folded state, the second limiting member is stowed relative to the second frame sub-segment to which the first end of the second limiting member is connected; and
a length of the first sub-beam is greater than a length of the second sub-beam, wherein the first sub-beam connected to the first end of the second sub-beam is adjacent to the second sub-beam connected to the first end of the second limiting member, and the second sub-beam does not in contact with the second limiting member in response to the screen frame being in the folded state.

17. A projection screen, wherein the projection screen comprises a screen frame and a flexible screen; wherein
the flexible screen conforms to a bearing surface of the screen frame; and
the screen frame comprises two oppositely-arranged first foldable frame segments two oppositely-arranged second foldable frame segments, and a third pivoting mechanism; wherein
each of the first foldable frame segments comprises two first frame sub-segments and a first pivoting mechanism, wherein first ends of the two first frame sub-segments are connected by the first pivoting mechanism, the first pivoting mechanism is configured to drive the two first frame sub-segments to fold or unfold around a first axis parallel to the bearing surface;
each of the second foldable frame segments comprises two second frame sub-segments, and at least one second foldable frame segment further comprises a second pivoting mechanism, wherein the second pivoting mechanism is connected between first ends of two second frame sub-segments of one second foldable frame segment, and the second pivoting mechanism is configured to drive two corresponding second frame sub-segments to fold or unfold around a second axis intersecting the bearing surface; and
the third pivoting mechanism is connected between a second end of a first frame sub-segment and a second end of a second frame sub-segment, and the third pivoting mechanism is configured to drive the second frame sub-segment to rotate relative to the first frame sub-segment around a fourth axis perpendicular to the bearing surface.

18. The projection screen according to claim 17, wherein
a side of the screen frame away from the bearing surface is provided with a bearing cavity, and an opening in communication with the bearing cavity; and
the projection screen further comprises a plurality of support rods, wherein an edge portion of the flexible screen is connected to the plurality of support rods after wrapping around an edge of the screen frame, and each of the support rods is snap-fitted into the bearing cavity through the opening.

19. The projection screen according to claim 17, wherein the projection screen further comprises a plurality of support rods and a plurality of locking screws; wherein
an edge portion of the flexible screen is connected to the plurality of support rods, and the edge portion of the flexible screen wraps around an edge of the screen frame; and
the locking screws pass through the support rods and is threaded into the screen frame.

20. The projection screen according to claim 19, wherein each of the support rods comprises a rod body and a locking strip; wherein
the locking strip is provided with a bearing cavity and an opening in communication with the bearing cavity, the bearing cavity extending along a side of the screen frame;
the edge of the flexible screen is connected to the rod body after partially wrapping the edge of the screen frame, and the rod body is clamped into the bearing cavity through the opening; and
the locking screws pass through the locking strip and screw into the screen frame.
